(19) United States
(12) Patent Application Publication
(10) Pub. No.: US 2026/0277646 A1
(43) Pub. Date: Sep. 17, 2026

(54) ACCESSING SOFTWARE COMPOSITION TOOLS VIA AUTONOMOUS SOFTWARE AGENTS AND MIRRORING AI ACTIONS IN GRAPHICAL USER INTERFACES

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US); Moritz Stephan, San Francisco, CA (US); Silas Alberti, San Francisco, CA (US); Gennady Korotkevich, Menlo Park, CA (US)

(21) Appl. No.: 19/561,159

(22) Filed: Mar. 9, 2026

Related U.S. Application Data
(60) Provisional application No. 63/770,816, filed on Mar. 12, 2025.

(51) Int. Cl. G06F 9/455; G06F 8/34; G06F 8/38; G06F 9/451

(52) U.S. Cl. CPC G06F 9/45533; G06F 8/34; G06F 8/38; G06F 9/451

(57) ABSTRACT

The present disclosure relates to systems, methods, and non-transitory computer-readable media that deploys an autonomous software agent and displays actions taken by the autonomous software agent on a graphical user interface on a user computing device. In particular, the disclosed systems provide an interactive browser of an independent virtual machine computing environment of the autonomous software agent for display within a graphical user interface. Moreover, the disclosed systems provide an application running on the independent virtual machine computing environment for display in the interactive browser.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy an autonomous software agent which operates within an independent virtual machine computing environment and mirrors actions executed by the autonomous software agent via interactive interfaces. To illustrate, in one or more embodiments, the disclosed systems receive a request to activate an autonomous software agent and as part of the request, receive a software task. Specifically, in response to the request, the disclosed systems deploy an autonomous software agent to perform the software task (e.g., generate computer code, create an application end-to-end, fine-tune an artificial intelligence model, debug computer code, etc.).

In one or more embodiments, the disclosed systems deploy an autonomous software agent that has a unique suite of software composition tools. In some embodiments, the disclosed systems provide an interactive browser, a shell, an interactive planner, and/or an integrated development environment to a graphical user interface. In some embodiments, the disclosed systems allow a user computing device to follow the autonomous software agent as it executes a software task. In some embodiments, the disclosed systems allow the user computing device to intervene within the workflow of an autonomous software agent.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system deploying an autonomous software agent and providing an interactive browser for display in a graphical user interface in accordance with one or more implementations;

FIGS. 2A-2J illustrate an example diagram and example graphical user interfaces of the autonomous software agent system generating an artificial intelligence plan responsive to a prompt in accordance with one or more implementations;

FIGS. 3A-3D illustrate an example diagram and example graphical user interfaces of the autonomous software agent system providing an interactive browser for a user computing device to follow an autonomous software agent in accordance with one or more implementations;

FIGS. 4A-4H illustrate an example diagram and example graphical user interfaces of the autonomous software agent system providing a shell tool for a user computing device to follow an autonomous software agent in accordance with one or more implementations;

FIG. 5 illustrates an example diagram of the autonomous software agent system providing an integrated development environment and enabling options to switch between different levels of autonomy in accordance with one or more implementations;

FIG. 6 illustrates an example diagram of an autonomous software agent IDE and a user computing device IDE in accordance with one or more implementations;

FIGS. 7A-7C illustrate example graphical user interfaces of an integrated development environment (IDE) of the autonomous software agent performing software coding tasks in accordance with one or more implementations;

FIG. 8 illustrates an example diagram of an architectural layer design of the autonomous software agent system which accesses various artificial intelligence models to enable an independent virtual machine computing environment of an autonomous software agent in accordance with one or more implementations;

FIG. 9 illustrates an example diagram of a virtual private cloud housing an independent virtual machine computing environment that is in communication with an autonomous agent model backend in accordance with one or more implementations;

FIG. 10 illustrates an example diagram of a frontend layer interacting with an autonomous software agent system ingestion layer and a virtual private cloud in accordance with one or more implementations;

FIG. 11 illustrates an example environment of the autonomous software agent system in accordance with one or more implementations;

FIG. 12 illustrates an example series of acts for providing an application running on an independent virtual machine computing environment within an interactive browser in accordance with one or more implementations;

FIG. 13 illustrates an example series of acts for providing for display in a graphical user interface, one or more commands entered by an autonomous software agent executing a software task in accordance with one or more implementations; and

FIG. 14 illustrates a block diagram of an exemplary computing device in accordance with one or more implementations.

### DETAILED DESCRIPTION

One or more embodiments described herein includes an autonomous software agent system that utilizes an autonomous software agent which operates within an independent virtual machine computing environment to execute a software task and further mirrors actions executed by the autonomous software agent on a graphical user interface of a user computing device. To illustrate, in one or more embodiments, an autonomous software agent system 100 deploys an autonomous software agent to independently complete software development tasks such as writing computer code tests, adding features to an existing code repository, adding functionality to an existing codebase, developing prototypes, and building integrations between software applications. In addition, in some embodiments, the autonomous software agent system 100 provides an interactive browser, an interactive shell, an integrated development environment, and an interactive planner for a user computing device to follow along/intervene within a development environment of a deployed autonomous software agent executing a software task.

As mentioned, the autonomous software agent system 100 deploys an autonomous software agent that operates within an independent virtual machine computing environment and the autonomous software agent is enabled to locally write computer code, test computer code, submit requests, and merge code into a codebase (e.g., utilizing a shell tool, a browser tool, an integrated development environment, and/or a planner tool). In other words, the autonomous software agent system 100 deploys one or more autonomous software agents to independently perform a variety of non-trivial tasks and further allows for a user computing device to make modifications as the autonomous software agent is executing a task, which enhances overall efficiency, accuracy, and operational flexibility of code development environments that leverage autonomous software agents.

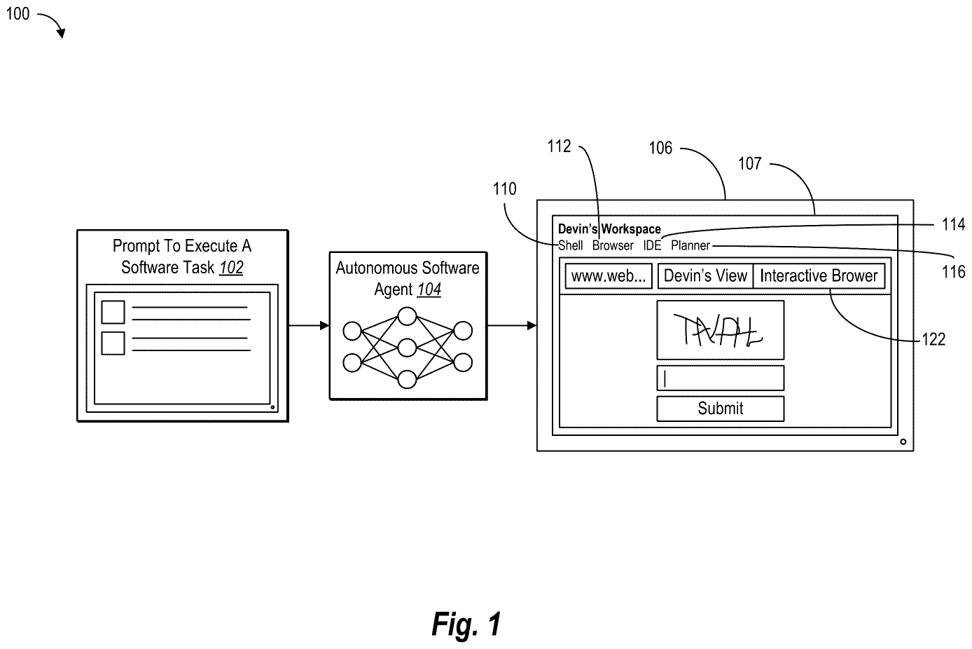

FIG. 1 illustrates an overview diagram of the autonomous software agent system 100 deploying an autonomous software agent to generate one or more artificial intelligence outputs responsive to a software task in accordance with one or more embodiments. For example, FIG. 1 shows the autonomous software agent system 100 accessing/receiving a prompt 102 to execute a software task.

In one or more embodiments, the prompt 102 refers to natural language instructions (from a user of a computing device), an application programming interface call, and/or a tag/mention in a third-party messaging application received by the autonomous software agent system 100 from a user computing device. In one or more embodiments, the prompt 102 refers to a request, a question, or an instruction submitted by a user corresponding to a computing device of a user account. In particular, the prompt 102 includes text instructions and/or image data received from a user corresponding to a computing device.

In one or more embodiments, a user computing device refers to a device that interacts with computer systems, accesses code repositories, writes computer code, and runs applications based on instructions received from the user. In some embodiments, a user computing device is part of a centralized computer code development platform (e.g., a computer code repository management system) with a plurality of additional users. Moreover, in some embodiments, the centralized computer code development platform is also accessed by an autonomous software agent (e.g., via access permissions granted to the autonomous software agent by one or more users of the centralized computer code development platform).

As shown in FIG. 1, in some embodiments, the autonomous software agent system 100 receives the prompt 102 via a chat interface between a user and the autonomous software agent system 100. In particular, the autonomous software agent system 100 provides the chat interface via a web browser, or a web application. In some embodiments, the autonomous software agent system 100 receives the prompt 102 via an application programming interface (API). In particular, a user computing device can build custom workflows using an API of the autonomous software agent system 100 and programmatically assign tasks for the autonomous software agent system 100 to execute. Further, with the API, users of computing devices can essentially plug in the autonomous software agent system 100 to any of their software development tools and internal tools.

In some embodiments, the autonomous software agent system 100 deploys an autonomous software agent in response to being triggered by a code editor. In particular, from another code editor/integrated development environment (IDE), users of computing devices can assign tasks to the autonomous software agent system 100 directly from their code editor/IDE (e.g., the autonomous software agent system 100 receives the prompt 102 from the code editor of a user).

In some embodiments, the autonomous software agent system 100 can deploy an autonomous software agent in response to being tagged/mentioned in a third-party messaging application (e.g., between a plurality of users). In particular, users of computing devices can tag the autonomous software agent system 100 directly from conversations they are having with colleagues in the third-party messaging application. Furthermore, the autonomous software agent system 100 will reply directly in the messaging thread and any user that is part of the third-party messaging application can submit instructions to the autonomous software agent system 100. In other words, the autonomous software agent system 100 receives the prompt 102 from a third-party messaging application between a plurality of users.

As further shown in FIG. 1, the autonomous software agent system 100 further performs an act of deploying an autonomous software agent 104 (e.g., a cloned virtual machine that is isolated and can perform tasks siloed from other virtual machine computing devices). In particular, the autonomous software agent system 100 deploys the autonomous software agent within an independent virtual machine computing environment and generates and runs code in its own isolated environment. In other words, the autonomous software agent 104 exists independently of a computing device of a user who submitted the prompt 102 to deploy the autonomous software agent 104 and performs tasks based on knowledge that is provided to it.

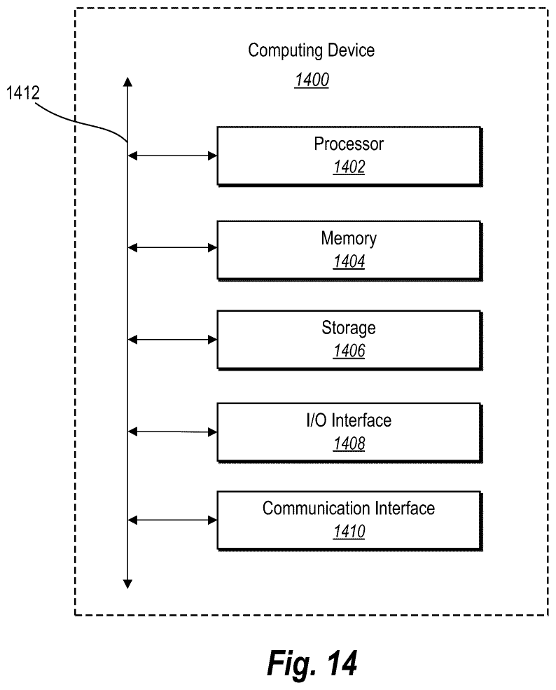

In one or more embodiments, the independent virtual machine computing environment refers to a software-based simulation that independently runs its own operating system and applications as a standalone machine. In particular, the independent virtual machine computing environment can correspond to a physical server that provides CPU, memory, storage, and networking (e.g., as discussed below in FIG. 14). In other words, for each instance of an autonomous software agent, the autonomous software agent system 100 can deploy a physical server to serve a specific instance of an autonomous software agent. Thus, a deployed autonomous software agent independently leverages its own independent computing environment.

In one or more embodiments, the autonomous software agent system 100 provides the autonomous software agent 104 with its own software development environment (e.g., the independent virtual machine computing environment with access to the computer software composition tools that are discussed in more detail below) to perform individualized tasks and not merely supplementary tasks (e.g., the autonomous software agent system 100 can utilize the autonomous software agent 104 to deploy its own codebase by replicating an existing codebase, make changes to an existing codebase, implement changes to a codebase, and run tests for computer code generated by the autonomous software agent 104).

In some embodiments, the autonomous software agent 104 includes a set of artificial intelligence models. In particular, the autonomous software agent 104 includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence. A language model is called a large language model (LLM) when it is trained on an enormous amount of data (e.g., a threshold amount of data) and/or has a large number of parameters.

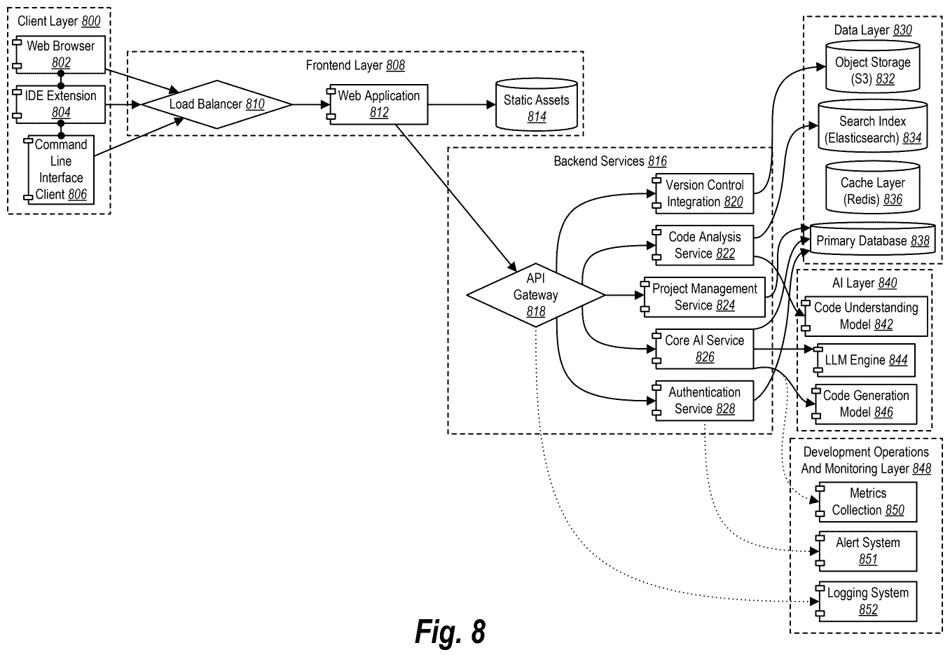

These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text. These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback. Additional details of the autonomous software agent are given below in the description of FIGS. 8-10.

As shown in FIG. 1, the autonomous software agent system 100 deploys the autonomous software agent 104 to access the computer software composition tools shown as a shell tool 110, a browser tool 112, an integrated development environment 114 (e.g., an editor), and a planner tool 116 within a graphical user interface 107. In particular, FIG. 1 shows the autonomous software agent system 100 providing the shell tool 110, the browser tool 112, the integrated development environment 114 (e.g., an editor), and the planner tool 116 to the graphical user interface 107 of a user computing device 106.

As mentioned above, the autonomous software agent system 100 mirrors actions of the autonomous software agent 104 as the autonomous software agent accesses/utilizes the computer software composition tools. In particular, the autonomous software agent system 100 can cause the graphical user interface 107 of the user computing device 106 to follow the autonomous software agent 104 as it switches between using the shell tool 110, the browser tool 112, the integrated development environment 114 (e.g., an editor), and the planner tool 116. Additionally, FIG. 1 shows the autonomous software agent system 100 providing an interactive browser option element 122 for the user computing device 106 to usurp control of the browser tool 112 from the autonomous software agent 104 within the independent virtual machine computing environment.

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer's device in order to supplement developer work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer's task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems are often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck as operating as a co-pilot developer to merely supplement a software developer's workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer's device (in order to supplement developer work), the autonomous software agent system 100 deploys an autonomous software agent that operates within an independent virtual machine computing environment.

In doing so, the autonomous software agent system 100 allows for an autonomous software agent to operate independently (or optionally with feedback from a user that is able to intervene) to solve non-trivial tasks, and it does not conflate or confuse context of other ongoing tasks. Specifically, the autonomous software agent system 100 silos/isolates autonomous software agents (e.g., to operate independently with fully featured computer software composition tools such as a shell tool, a browser tool, an integrated development environment, and/or a planner tool) such that the autonomous software agents can accurately perform their assigned software tasks without being bogged down by additional information.

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that matches a determined context, and how to choose between various artificial intelligence models to accomplish various software tasks. In some embodiments, the autonomous software agent system 100 allows a user computing device to configure an autonomous software agent environment and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor (e.g., integrated development environment), and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Additionally, in one or more embodiments, the autonomous software agent system 100 provides an interactive browser for display in a graphical user interface (e.g., of a user computing device). In particular, the autonomous software agent system 100 provides for display actions taken within a web browser by an autonomous software agent as it executes a software task. Moreover, in some embodiments, the autonomous software agent system 100 provides an interactive browser option element for a user computing device to usurp browser control from the autonomous software agent. In providing an interactive browser, the autonomous software agent system 100 enables a user computing device to assist an autonomous software agent in enhancing the accuracy of software task execution.

Further, in one or more embodiments, autonomous software agent system 100 provides additional interactive tools (e.g., a shell, an IDE, a planner tool) to a graphical user interface. In particular, the additional interactive tools mirror actions performed by an autonomous software agent executing a software task. Moreover, in some embodiments, the additional interactive tools allow for a user computing device to accurately understand the workflow and thought processes of an autonomous software agent. Further, in some embodiments, the additional interactive tools also allow for appropriate intervention to enhance the accuracy of software task execution by an autonomous software agent.

Relatedly, the autonomous software agent system 100 also improves computational efficiency of software tasks by enabling options for a user of a computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools. In particular, a user of a computing device can follow an autonomous software agent as it switches between a shell tool, a browser tool, an integrated development environment, and/or a planner tool to execute a software task. In doing so, the autonomous software agent system 100 saves computational resources and time as a user can more efficiently understand the process of an autonomous software agent (e.g., as it performs a task or after it performs a task) and the user can intervene and one or more points in the development session to aid/assist an autonomous software agent.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools (e.g., browser, planner, editor, and shell), the autonomous software agent acts as an advanced reasoning tool to complete non-trivial tasks. Accordingly, the autonomous software agent system 100 enhances the flexibility of operations in performing code generation tasks relative to existing systems.

Furthermore, providing the autonomous software agent system 100 with an IDE, shell interface, and browser within its own virtual machine further improves deterministic execution and reproducibility. Conventional development systems frequently suffer from dependency mismatches, configuration drift, and non-reproducible builds. By maintaining controlled environment configurations and dependency states within the virtual machine, the autonomous software agent system 100 ensures consistent runtime conditions, reproducible build artifacts, and repeatable testing outcomes.

Additionally, the coordinated integration of the virtual machine, IDE, shell interface, planner tool, and browser tool reduces cascading error propagation during automated code generation. For example, the planner tool monitors intermediate results and initiates selective rollback via virtual machine snapshotting, localized file modification within the IDE, and controlled shell-level command execution. This minimizes system-wide reinitialization events and reduces computational overhead compared to conventional automated systems lacking structured planning and isolation.

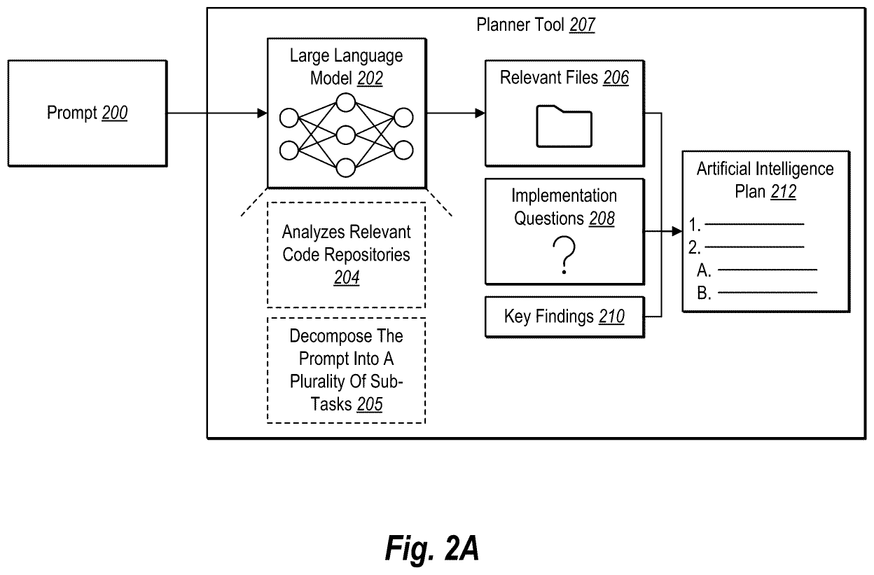

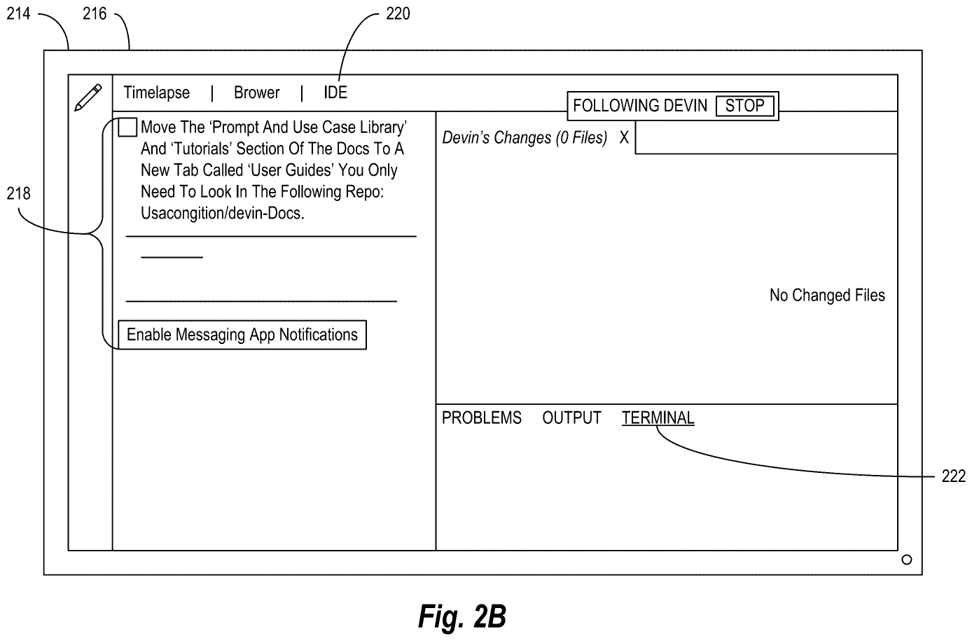

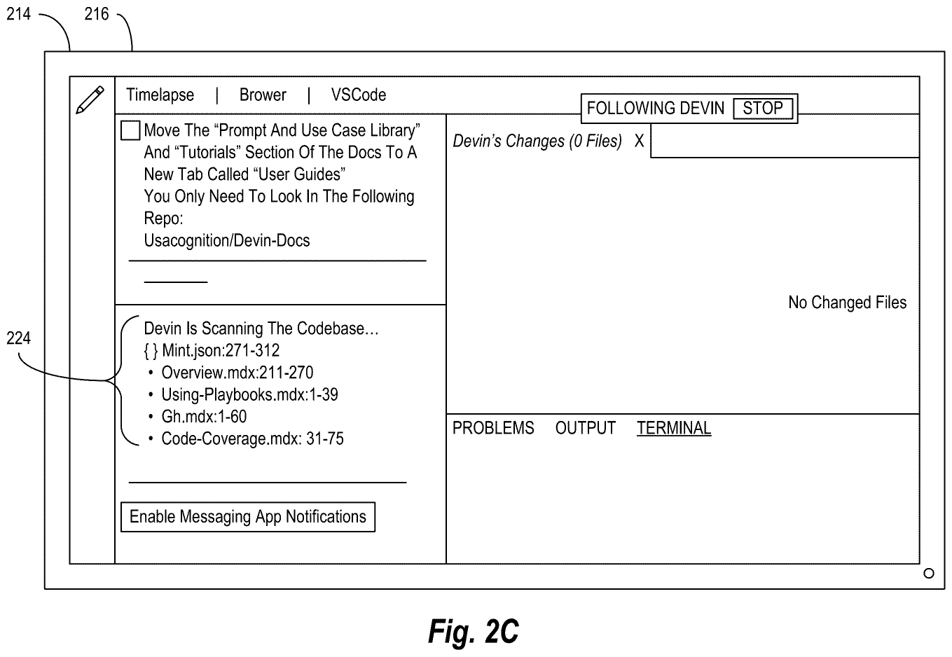

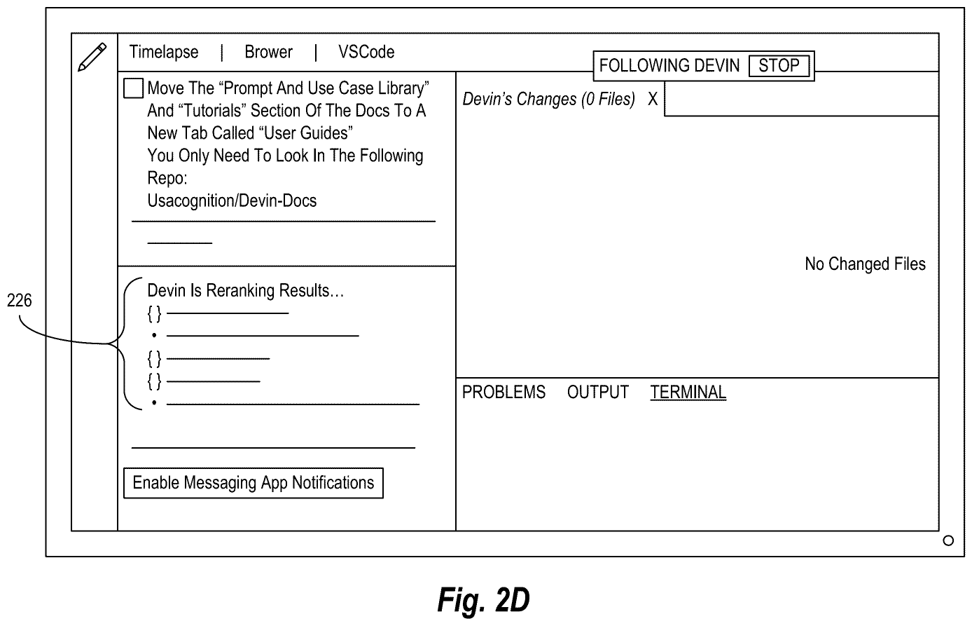

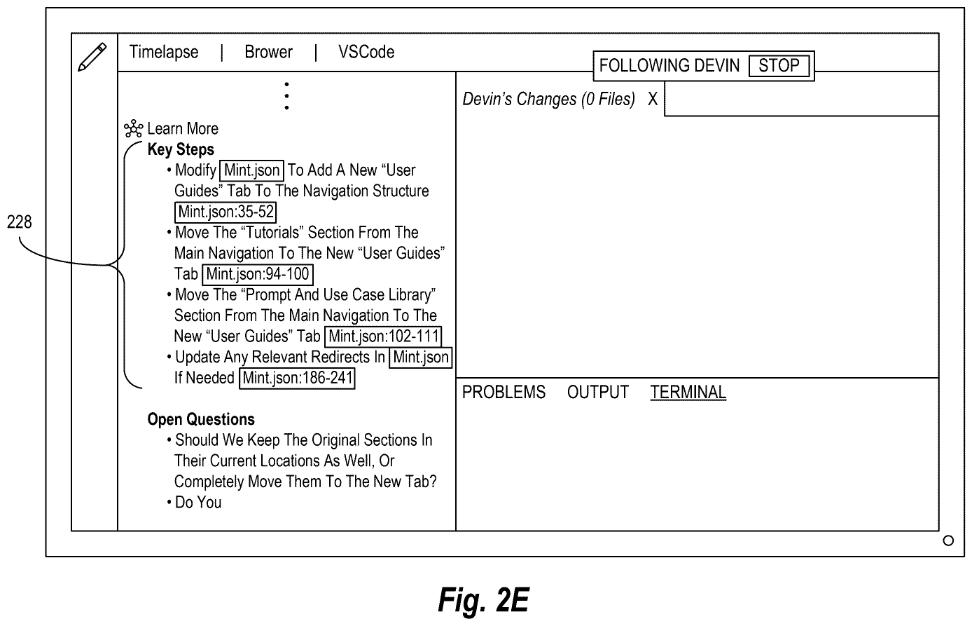

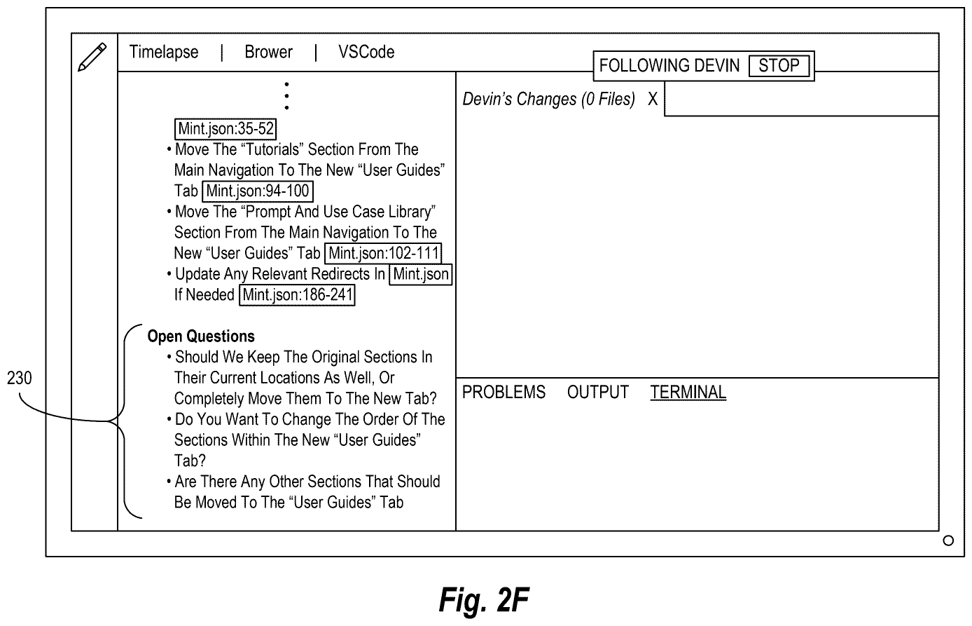

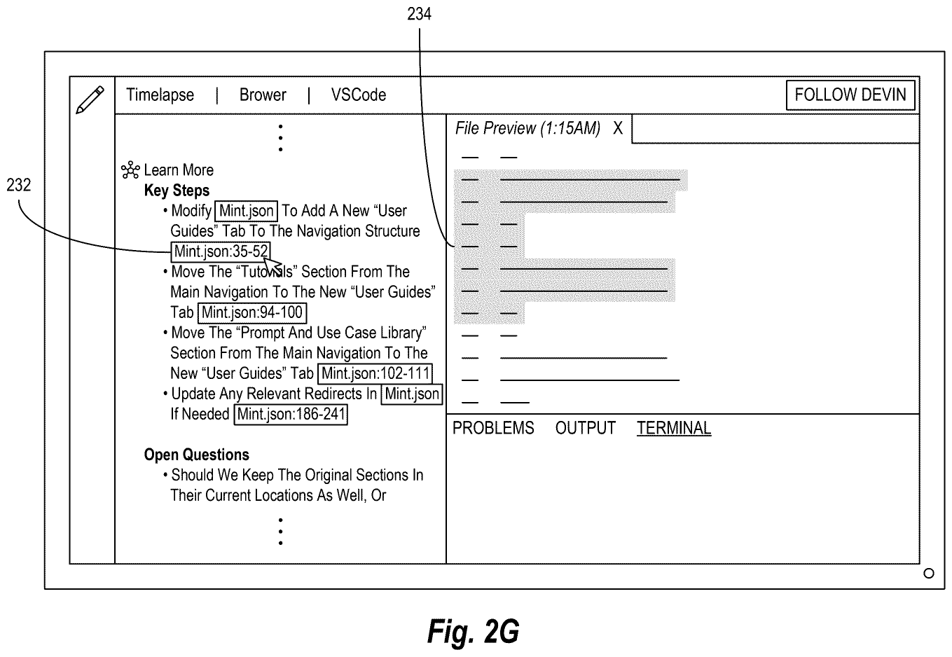

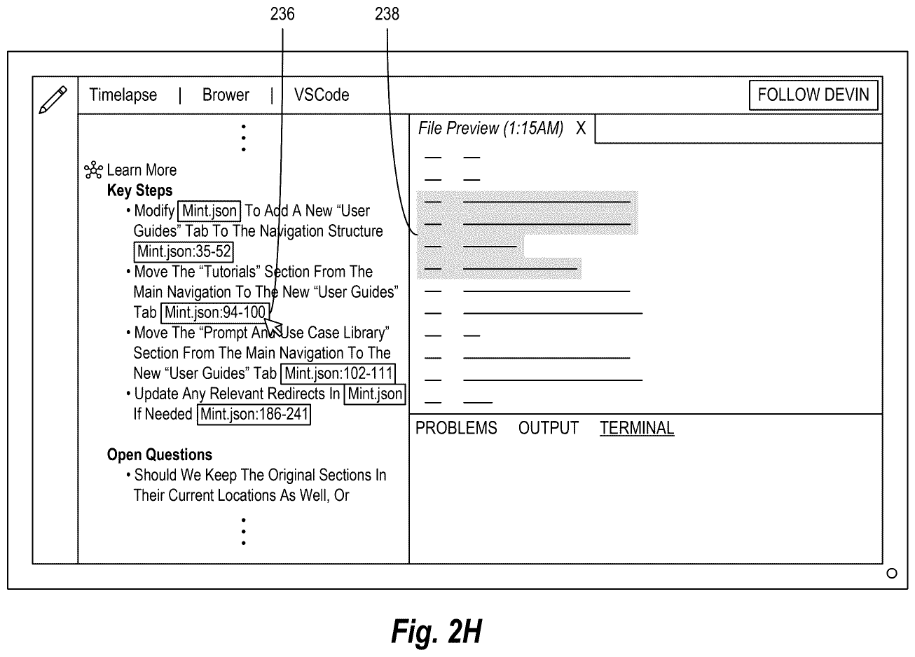

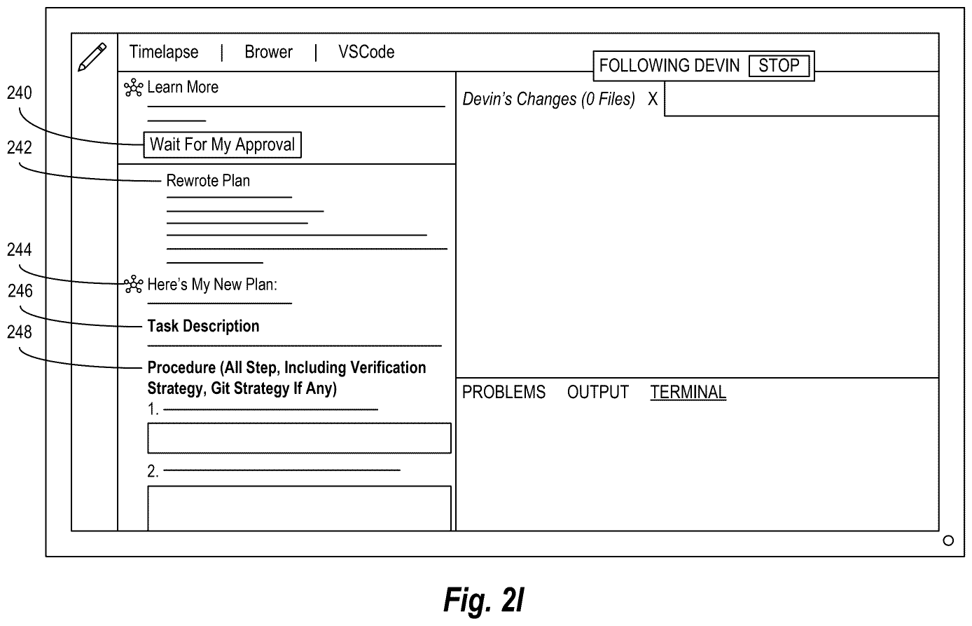

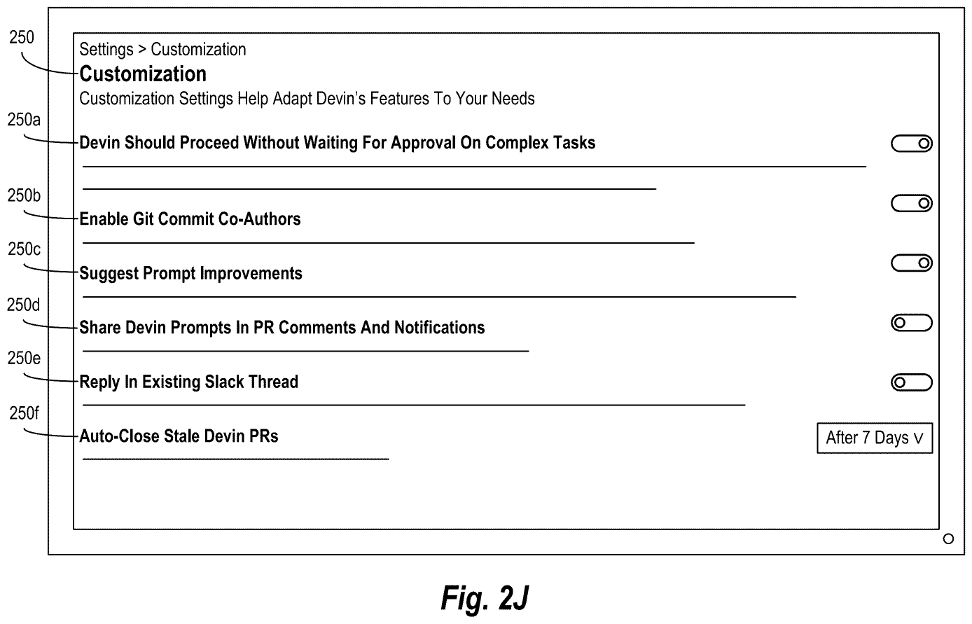

FIG. 2A illustrates the autonomous software agent system 100 generating an artificial intelligence plan in accordance with one or more embodiments. For example, FIG. 2A shows the autonomous software agent system 100 accessing/receiving a prompt 200 and utilizing a large language model 202 (e.g., a planning model) to analyze the prompt 200. In particular, FIG. 2A shows the autonomous software agent system 100 utilizing the large language model 202 to perform an act 205 of decomposing the prompt 200 into a plurality of sub-tasks.

In one or more embodiments, the autonomous software agent system 100 utilizes a planner tool 207 (e.g., to analyze code and decompose a prompt) to improve the efficiency and accuracy of executing a software task from the prompt 200. More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 207 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 207 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 207 is configured to decompose complex objectives into a sequence of actionable subtasks, determine dependencies and ordering among subtasks, and construct an execution plan consumable by downstream components such as code generation modules, debugging modules, the browser tool, the shell tool, IDE, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 207 employs prompt-based reasoning, chain-of-thought inference, tree search, beam search, Monte Carlo sampling, reinforcement learning-based policy selection, or combinations thereof to evaluate multiple candidate plans and select or refine a plan according to defined optimization metrics. The planner tool 207 may further incorporate memory mechanisms, including contextual embeddings, vector databases, episodic execution logs, or persistent state representations, to inform plan generation based on prior interactions or historical outcomes. The planner tool 207 may monitor intermediate execution results and dynamically revise, re-order, expand, or prune subtasks based on feedback including compiler diagnostics, runtime errors, test failures, environmental changes, or external tool responses. In this manner, planner tool 207 supports iterative, adaptive, reactive, or predictive planning strategies. In some embodiments, the planner tool 207 operates as a distinct module that communicates with other components of autonomous software agent system 100 via structured messages, application programming interfaces (APIs), or message-passing protocols.

In some embodiments, the autonomous software agent system 100 utilizes the planner tool 207 to generate a running “to do” list. In particular, the autonomous software agent system 100 can use the planner tool 207 to break down the prompt 200 and to infer one or more intents of the prompt 200. In one or more embodiments, the autonomous software agent system 100 utilizes the planner tool 207 to assist a user in visualizing how an autonomous software agent (e.g., deployed by the autonomous software agent system 100) plans and thinks through solving a problem, such as a software task as indicated in the prompt 200.

In one or more embodiments, a software task refers to a defined unit of work in a software project to be planned, assigned, executed and/or completed. For example, the software task refers to a specific software component for the autonomous software agent system 100 to build, change, fix, and/or maintain based on requirements of the prompt 200. In other words, the software task refers to a discrete, actionable piece of work that contributes to the development, maintenance, or improvement of a software system.

More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

As shown in FIG. 2A, the autonomous software agent system 100 utilizes the large language model 202 (e.g., a planning model) to analyze the prompt 200. In one or more embodiments, the autonomous software agent system 100 utilizes the large language model 202 that leverages retrieval-augmented generation (RAG) to generate an artificial intelligence plan 212. In some embodiments, retrieval-augmented generation refers to retrieving relevant information from an external database or knowledge source in context of the prompt 200. In particular, the autonomous software agent system 100 can utilize RAG (e.g., which includes using the large language model 202) to generate a response (e.g., the artificial intelligence plan 212) by leveraging both the retrieved information (from an external source) and its own internal knowledge base. In particular, the autonomous software agent system 100 leverages RAG, which includes an input query, information retrieval, and response generation to perform a task of generating the artificial intelligence plan 212.

In one or more embodiments, the autonomous software agent system 100 further utilizes the large language model 202 to perform an act of extracting a meta-task from the prompt 200. Moreover, in some embodiments, the autonomous software agent system 100 performs an act of extracting intermediate tasks (e.g., sub-tasks) from the meta-task. In one or more embodiments, the autonomous software agent system 100 analyzes the prompt 200, determines an intent (e.g., a meta-task) of the prompt 200, and determines discrete sub-tasks (e.g., intermediate tasks).

In particular, the autonomous software agent system 100 can prompt the large language model 202 to divide the prompt 200 into manageable and discrete sub-portions. In other words, the autonomous software agent system 100 prompts the large language model 202 to identify tasks that point to different code repositories, data sources, and systems as being their own sub-task. In particular, the autonomous software agent system 100 can prompt the large language model 202 and include example breakdowns of example requests.

Moreover, in some embodiments, the autonomous software agent system 100 trains the large language model 202 with example datasets for breaking down a request into a meta-task and a plurality of sub-tasks. In particular, the autonomous software agent system 100 trains the large language model 202 by having it generate a predicted artificial intelligence plan and then comparing the prediction to a ground truth reference.

As shown in FIG. 2A, the autonomous software agent system 100 further performs an act 204 of analyzing relevant code repositories for the prompt 200. In one or more embodiments, a code repository refers to a centralized location where software computer code is stored, managed, and controlled (e.g., controlled for different deployment versions such as development, web application, cloud, etc.). In particular, the code repository includes computer code, computer code documentation (e.g., files explaining how to use, setup, and contribute to one or more projects), configuration files (e.g., environment configuration, application configuration, deployment configuration, etc.), and assets (e.g., images, CSS files, JavaScript files, fonts, external libraries, audio/video files, etc.).

In other words, relevant code repositories refer to a context of the prompt 200, such as whether the prompt 200 points towards a development environment, a testing environment, a production environment, a specific type of application, etc. Moreover, in one or more embodiments, the autonomous software agent system 100 performs the act 205 of decomposing the prompt 200 into a plurality of sub-tasks and further identifies the relevant code repositories based on the plurality of sub-tasks.

As shown in FIG. 2A, the autonomous software agent system 100 performs the act 204 of decomposing the prompt 200 and the act 205 of analyzing the code repositories. In doing so, the autonomous software agent system 100 can identify relevant files 206, generate implementation questions 208, and generate key findings 210. In one or more embodiments, the relevant files 206 refer to source code, configuration files, data files, scripts, and/or code dependencies for a specific software task indicated (e.g., implied or expressly indicated) by the prompt 200.

In one or more embodiments, the implementation questions 208 refer to technical questions about how a software task should be built, structured, and integrated. In particular, the implementation questions 208 can cover logic, tools, constraints, and edge cases to complete a task. In one or more embodiments, the key findings 210 refer to insights, constraints, risks, and technical realities of starting/executing a software task indicated by the prompt 200.

As shown in FIG. 2A, the autonomous software agent system 100 utilizes the large language model 202 to generate the artificial intelligence plan 212 to execute a software task from the act 205 of decomposing the prompt 200, the relevant files 206, the implementation questions 208, and/or the key findings 210. In particular, the autonomous software agent system 100 generates the artificial intelligence plan 212 which includes a meta-task extracted from the prompt 200 and intermediate tasks extracted from the meta-task.

In one or more embodiments, the autonomous software agent system 100 provides the artificial intelligence plan 212 to a graphical user interface of a computing device. In particular, the autonomous software agent system 100 provides the artificial intelligence plan 212 to receive approval or modification from a user of a computing device. This is described in more detail below in the description of FIGS. 2B-2J.

FIG. 2B illustrates the autonomous software agent system 100 receiving a prompt from a user computing device via a chat interface in accordance with one or more embodiments. For example, FIG. 2B shows the autonomous software agent system 100 providing for display on a graphical user interface 216 of a user computing device 214, a chat interface 218 between the user computing device 214 and the autonomous software agent system 100.

As shown in FIG. 2B, the autonomous software agent system 100 receives a prompt of “move the ‘prompt and use case library’ and ‘tutorials’ section of the docs to a new tab called ‘user guides’ you only need to look in the following repo: usacongition/devin-docs.” Moreover, FIG. 2B shows that the graphical user interface 216 also displays an integrated development environment 220 and a terminal 222.

FIG. 2C illustrates autonomous software agent system 100 performing the act 204 (e.g., described with respect to FIG. 2A) of analyzing relevant code repositories in accordance with one or more embodiments. For example, FIG. 2C shows an analysis 224 that reads Devin is scanning the codebase . . . { } mint.json: 271-312, overview.mdx: 211-270, using-playbooks.mdx: 1-39, gh.mdx: 1-60, and code-coverage.mdx: 31-75. In other words, the autonomous software agent system 100 parses code repositories connected with the autonomous software agent system 100 in context of the prompt and determines the relevant portions of the connected code repositories with respect to the prompt. As described above, the autonomous software agent system 100 can utilize a large language model to break down a prompt and identify expressly or implied code repositories that are relevant to the prompt.

Moreover, FIG. 2D shows the autonomous software agent system 100 performing an act 226 of (re) ranking results. For example, the autonomous software agent system 100 scans the connected code repositories to identify relevant portions of the connected code repositories and ranks/re-ranks results find from scanning the connected code repositories. In addition, FIG. 2E illustrates the autonomous software agent system 100 providing key steps 228 for display on the graphical user interface 216. For example, the graphical user interface 216 shows the autonomous software agent system 100 generating the key steps 228 as modify mint.json to add a new “User Guides” tab to the navigation structure mint.json: 35-52; move the “tutorials” section from the main navigation to the new “user guides” tab mint.json: 94-100; move the “prompt and use case library” section from the main navigation to the new “user guides” tab mint.json: 102-111; update any relevant redirects in mint.json if needed mint.json: 186-241.

FIG. 2F shows the autonomous software agent system 100 providing open questions 230 for display on the graphical user interface 216. In particular, FIG. 2F shows the open questions 230 (e.g., the implementation questions 208 discussed above in FIG. 2A) as should we keep the original sections in their current locations as well, or completely move them to the new tab? Do you want to change the order of the sections within the new “User Guides” tab? Are there any other sections that should be moved to the “User Guides” tab.

Additionally, FIG. 2G shows the autonomous software agent system 100 receiving via the graphical user interface 216, an interaction 232 with a key step in the key steps 228. In particular, the autonomous software agent system 100 can receive a hover action (e.g., from the graphical user interface 216 of the user computing device 214) over a specific key step, and in response, the autonomous software agent system 100 highlights or emphasizes a relevant portion of code shown in the integrated development environment 220. In some embodiments, the autonomous software agent system 100 causes the graphical user interface 216 to show a specific file (e.g., a relevant file) opened in the integrated development environment 220 and further highlights a relevant portion 234 of the opened file in response to detecting a hover action (e.g., the interaction 232).

Moreover, FIG. 2H shows the autonomous software agent system 100 receiving via the graphical user interface 216, an additional interaction 236 with another key step in the key steps 228 (e.g., from the graphical user interface 216 of the user computing device 214). As mentioned, in some embodiments, the autonomous software agent system 100 causes the graphical user interface 216 to show a specific file (e.g., a relevant file) opened in the integrated development environment 220 and further highlights an additional relevant portion 238 of the opened file in response to detecting a hover action.

FIG. 2I shows the autonomous software agent system 100 rewriting an artificial intelligence plan and providing one or more options for display in a graphical user interface in accordance with one or more embodiments. For example, FIG. 2I shows the autonomous software agent system 100 indicating that an autonomous software agent is working on an artificial intelligence plan and providing a wait option element 240. In particular, a selection of the wait option element 240 causes the autonomous software agent system 100 to receive approval from a user computing device before proceeding with executing an artificial intelligence plan (e.g., generated from analyzing a prompt received from the user computing device 214).

As shown in FIG. 2I, the autonomous software agent system 100 performs an act 242 of rewriting a plan (e.g., an artificial intelligence plan). In some embodiments, the autonomous software agent system 100 generates an initial artificial intelligence plan and further receives one or more user inputs modifying the initial artificial intelligence plan. In receiving the one or more user inputs, the autonomous software agent system 100 can generate a rewritten artificial intelligence plan. In addition, FIG. 2I shows the autonomous software agent system 100 generating a rewritten plan 244.

For example, FIG. 2I shows a task description 246 (e.g., move the ‘prompt and use case library’ and ‘tutorials’ section of the docs to a new tab called ‘user guides’ in the Devin documentation website), and a procedure 248 (e.g., which indicates steps for the autonomous software agent system 100 to execute a software task). Moreover, FIG. 2J shows the autonomous software agent system 100 providing customization options in accordance with one or more embodiments.

For example, FIG. 2J shows customization settings 250 that include a first customization option 250a (e.g., the autonomous software agent system 100 should proceed without waiting for approval on complex tasks), a second customization option 250b (enable Git commit co-authors), a third customization option 250c (e.g., suggest prompt improvements), a fourth customization option 250d (share prompts in pull request comments and notifications), a fifth customization option 250e (e.g., reply in existing messaging application thread), and a sixth customization option 250f (e.g., auto-close stale pull requests).

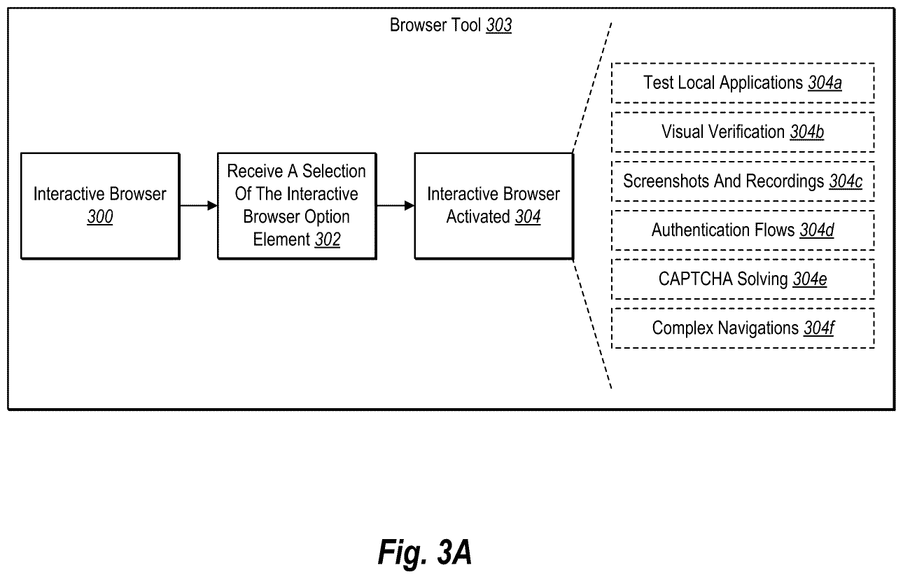

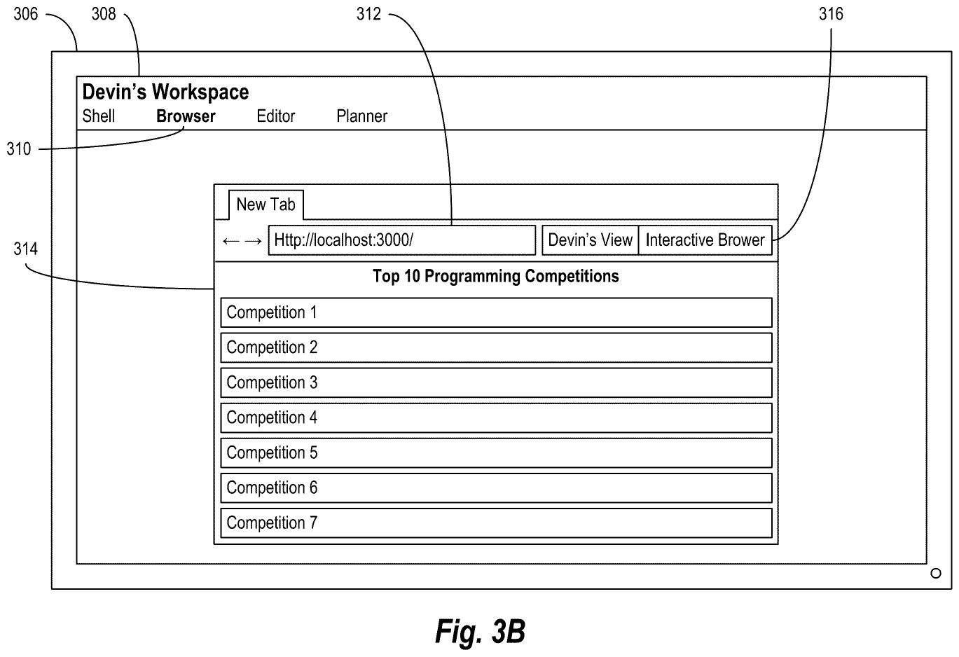

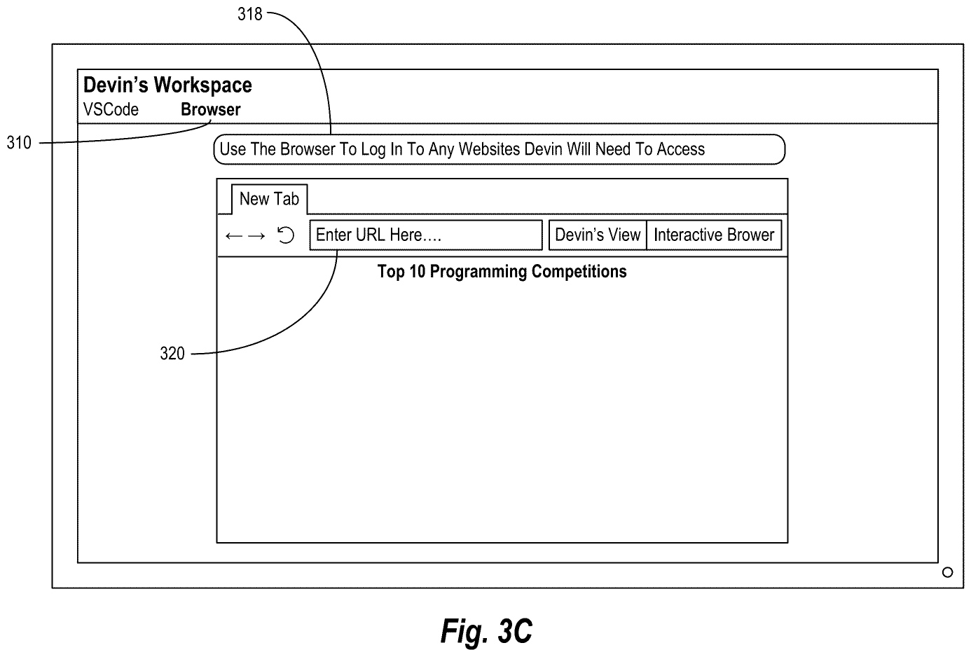

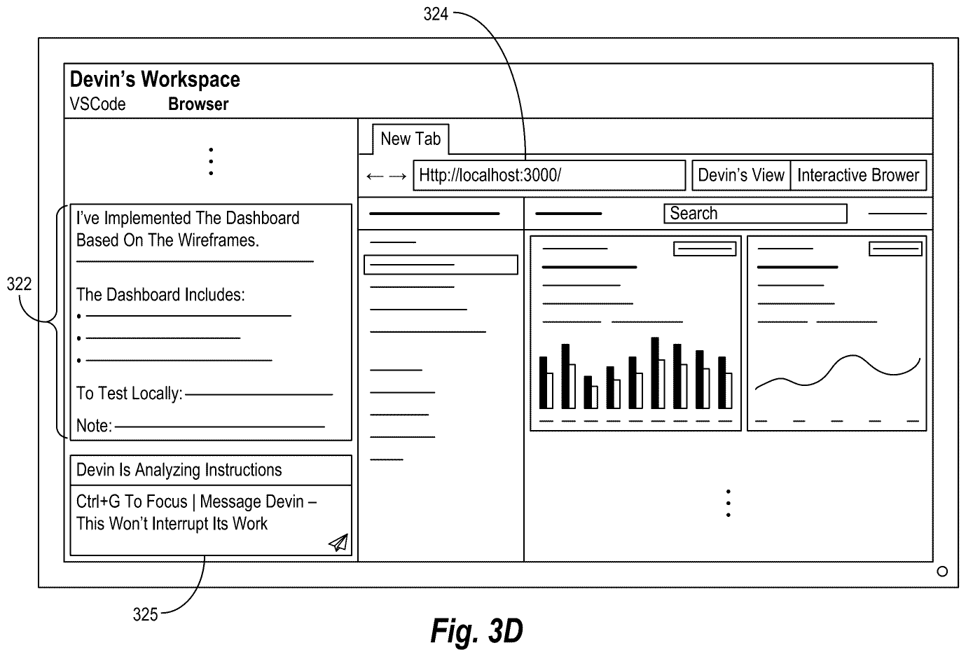

FIG. 3A illustrates the autonomous software agent system 100 providing an interactive browser to a graphical user interface of a user computing device in accordance with one or more embodiments. For example, FIG. 3A shows the autonomous software agent system 100 providing an interactive browser 300 to a graphical user interface of a user computing device. In particular, the interactive browser 300 mirrors website browsing actions as the autonomous software agent system 100 utilizes a browser tool to execute a software task.

In some embodiments, the autonomous software agent system 100 utilizes a browser tool 303, which refers to an interface that an autonomous software agent utilizes to browse documentation on the World Wide Web, perform web browsing navigation actions, tests web applications, download information, and upload information.

As used herein, a browser tool 303 (or simply browser) refers to a software component executing within an independent virtual machine computing environment and configured to retrieve, render, interpret, and interact with network-accessible resources on behalf of an autonomous software agent system 100. A browser tool 303 operates as a controlled network interaction interface within the independent virtual machine computing environment and provides the autonomous software agent system 100 with programmatic access to web content, application interfaces, documentation repositories, APIs, development resources, and other remote computing services. A browser tool 303 may implement one or more communication protocols, including HTTP, HTTPS, WebSocket, or other network transport protocols.

In the context of the autonomous software agent system 100, a browser tool 303 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 303 is configured to expose structured outputs such as DOM trees, accessibility trees, rendered text, event traces, console logs, or network traces-rather than or in addition to graphical output. A browser tool 303 may operate in headless mode and may be programmatically controlled via an automation interface.

A browser tool 303, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool 303 encompasses any web client, headless browsing engine, embedded rendering engine, automated browsing framework, or network-interaction module configured to retrieve and interact with remote content within a virtualized execution environment controlled by the autonomous software agent system 100.

In one or more embodiments, the autonomous software agent system 100 utilizes the browser tool 303 to perform a first navigation step, a second navigation step, and a third navigation step. In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website pages is associated with an entity/organization.

In one or more embodiments, the autonomous software agent system 100 utilizes the browser tool 303 to obtain information from a website page or other information source accessible via the Internet. In some embodiments, the autonomous software agent system 100 determines whether a particular portion of a website page is relevant to a prompt to execute a software task. In some embodiments, the autonomous software agent system 100 utilizes a large language model (e.g., a website relevance model) to determine the relevance of a sub-portion, portion, or entire website page in executing a software task.

In other words, website pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to an autonomous software agent for further processing. In doing so, the autonomous software agent system 100 enables an autonomous software agent to process a large amount of data from website pages without performance degradation.

In one or more embodiments, the autonomous software agent system 100 utilizes a large language model to perform an act of determining a document object model (DOM) of a website page. In particular, the autonomous software agent system 100 passes a website page to a large language model to determine a document object model of the website page.

In one or more embodiments, a document object model refers to a structured, hierarchical representation of a webpage's content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website page. To illustrate, DOM objects are part of a DOM tree structure, where each node of the DOM tree structure corresponds to a specific element in a website page.

In one or more embodiments, the autonomous software agent system 100 utilizes the large language model to perform an act of identifying relevant document object model elements (e.g., DOM elements). In particular, the autonomous software agent system 100 prompts the large language model to identify relevant DOM elements in context of a prompt. In other words, the autonomous software agent system 100 utilizes the large language model to distill a website page into a relevant set of elements for the prompt.

In one or more embodiments, the autonomous software agent system 100 utilizes a large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool) and generates the simplified DOM tree.

In one or more embodiments, the simplified DOM tree refers to distilled document object model structure and/or a distilled hierarchical representation of a webpage's content. In particular, the simplified DOM tree includes a hierarchy of nodes and elements from the website page that are relevant to the prompt. In other words, the simplified DOM tree contains fewer website page elements relative to an initially determined DOM tree from the website page.

In context of the above description, the autonomous software agent system 100 provides the interactive browser 300 to a user computing device for use cases such as testing local applications, visual verification, screenshots and recordings, authentication flows, CAPTCHA solving, and complex navigation. In particular, FIG. 3A shows the autonomous software agent system 100 receiving a selection of an interactive browser option element 302. In response to the selection of the interactive browser option element 302, the autonomous software agent system 100 performs an act 304 of activating an interactive browser, which includes providing options mentioned above, such as an act 304a of testing local applications, an act 304b of visual verification, an act 304c of screenshots and recordings, and act 304d of authentication flows, an act 304e of CAPTCHA solving, and an act 304f of complex navigation.

In some embodiments, testing local applications involves running and validating software on a local development machine, rather than in a staging or production environment. In other words, testing local applications involves verifying changes in an application before sharing or deploying the application. In particular, testing local applications includes executing software to verify functionality, catch bugs, and confirming integrations while an autonomous software agent iterates on a specific software task.

In some embodiments, visual verification involves using the interactive browser 300 to verify that user interface changes look correct in a browser. In other words, a user computing device can follow an autonomous software agent as it opens an application in a browser and verify user interface elements in the browser. In some embodiments, screenshots and recordings refers to the autonomous software agent system 100 utilizing the interactive browser 300 to capture testing or results of executing sub-tasks/tasks of a software task. In particular, if the autonomous software agent system 100 does not capture actions of an autonomous software agent in real-time, the autonomous software agent system 100 can have the autonomous software agent display screenshots/recordings via the interactive browser 300 for a user computing device to review.

In one or more embodiments, the autonomous software agent system 100 activates the interactive browser and cedes control of the interactive browser to a user computing device. Additionally, the autonomous software agent system 100 receives one or more modifications to stylistic user interface computer code. In particular, the autonomous software agent system 100 provides the interactive browser for the user computing to provide one or more visual verification tasks. If the user computing device determines visual deficiencies, the autonomous software agent system 100 can receive input via an integrated development environment of an autonomous software agent. In particular, the autonomous software agent system 100 can provide access to the integrated development environment of the autonomous software agent to modify stylistic user interface computer code written by the autonomous software agent.

In some embodiments, authentication flows refer to login steps (e.g., ordered actions to authenticate and gain access to an application), multi-factor authentication challenges (e.g., additional verification requests that occur after or alongside a password to confirm a user's identity using a second or third factor), or OAuth flows (e.g., standardized authorization sequences that allow users to grant an application limited access to their data on another service without sharing their password) that an autonomous software agent cannot automatically handle.

In some embodiments, CAPTCHA solving refers to a process of successfully completing a CAPTCHA challenge (e.g., completely automated public Turing test to tell computers and humans apart). In particular, the CAPTCHA solving refers to a security mechanism designed to distinguish between human users and automated programs (e.g., bots). To illustrate, CAPTCHA solving can include text recognition, image selection, checkbox interaction, puzzle completion, and audio interpretation.

Further, in some embodiments, the autonomous software agent system 100 can receive from a user computing device (e.g., controlling the interactive browser) user input to resolve the CAPTCHA challenge (e.g., an authentication challenge designed for humans). Additionally, the autonomous software agent system 100 can receive a selection (e.g., from the user computing device) of a browser control release option element. In doing so, the autonomous software agent system 100 can utilize an autonomous software agent to resume executing a software task (e.g., based on receiving the user input to resolve the authentication challenge).

In some embodiments, complex navigations refer to interaction flows within a website page that require multi-step, stateful, context-aware behavior. In particular, complex navigations refer to website actions that may be easy for humans to accomplish but difficult for automated bots to accomplish. To illustrate, the complex navigations can include multi-step authentication flows (e.g., multi-factor authentication), dynamic loading of web pages that do not fully display content without a full-page refresh, interactive UI elements (e.g., dragging sliders, rotating objects, etc.), conditional form logic, and rate-limited flows (e.g., queue systems, cart expiration timers, dynamic availability updates).

In one or more embodiments, the autonomous software agent system 100 receives one or more website browsing actions to assist an autonomous software agent in executing a software task. In particular, the autonomous software agent system 100 receives one or more website browsing actions (e.g., user inputs) and resumes execution of a software task. In other words, the autonomous software agent system 100 receives a release of the browser control from the user computing device and allows an autonomous software agent to resume an execution of the software task.

FIG. 3B shows the autonomous software agent system 100 providing an interactive browser for display in a graphical user interface in accordance with one or more embodiments. For example, FIG. 3B shows a graphical user interface 308 of a user computing device 306. Further, FIG. 3B shows a browser tab 310 that indicates an autonomous software agent is currently using a browser tool to perform a software task.

FIG. 3B shows a website domain 312 that indicates an autonomous software agent is testing a local application via a website browser 314. Moreover, FIG. 3B shows an interactive browser option element 316. As mentioned above, in response to a selection of the interactive browser option element 316, the autonomous software agent system 100 cedes browser control of the application running on the independent virtual machine computing environment to a computing device controlled by a user.

FIG. 3C shows that autonomous software agent system 100 causes the browser tab 310 to show guidance instruction 318 that reads use the browser to log in to any websites Devin will need access to. Further, FIG. 3C shows a website browser input option 320 for an autonomous software agent to input a website domain and/or for a user computing device to usurp browser control and enter a website domain.

FIG. 3D shows a chat interface 322 which includes interactions between a user computing device and the autonomous software agent system 100. In particular, the chat interface 322 reads “I've implemented the dashboard based on the wireframes . . . the dashboard includes . . . ” In particular, FIG. 3D shows an interactive browser 324 that displays the dashboard created by an autonomous software agent while executing a task/sub-task of a software task. Further, FIG. 3D shows a text input element 325 for submitting additional instructions via the chat interface 322.

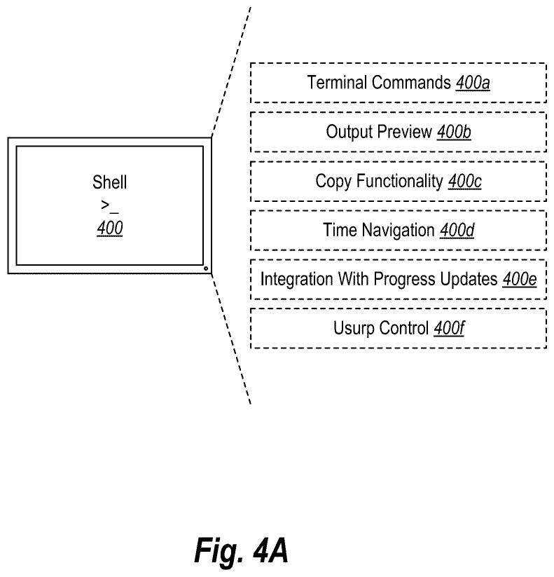

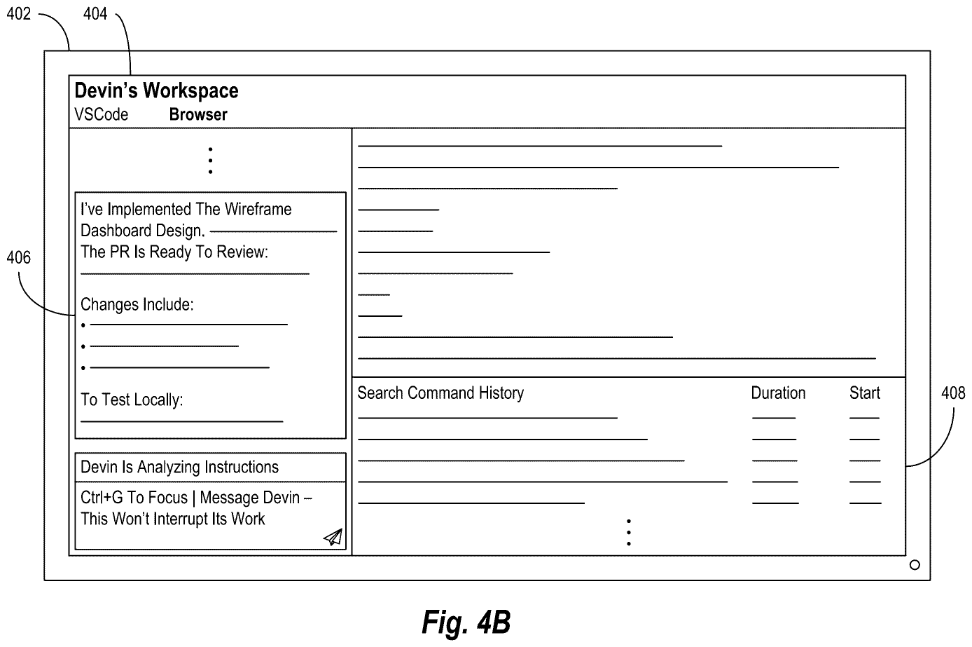

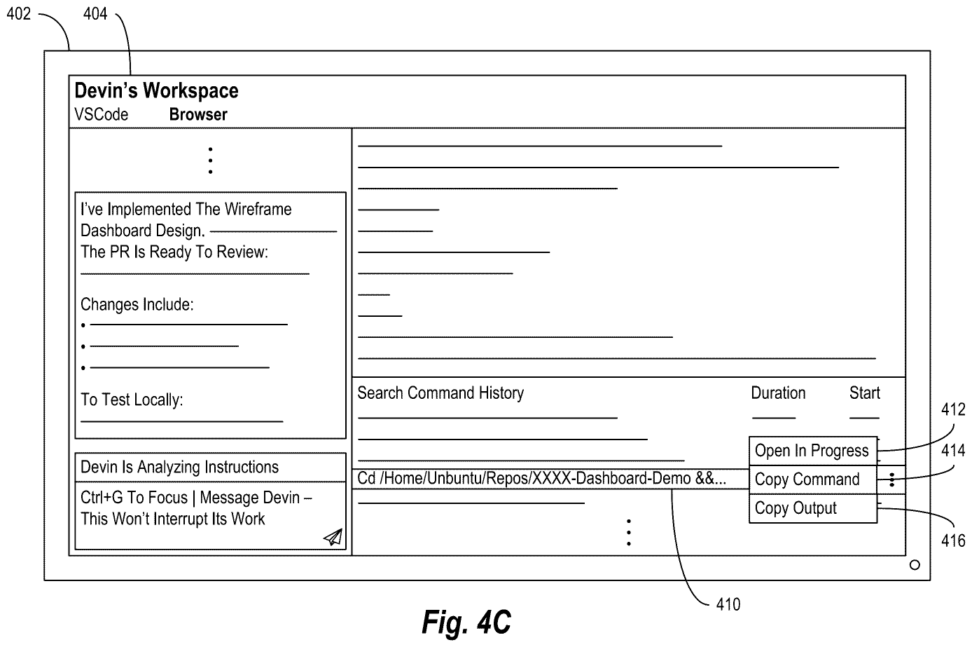

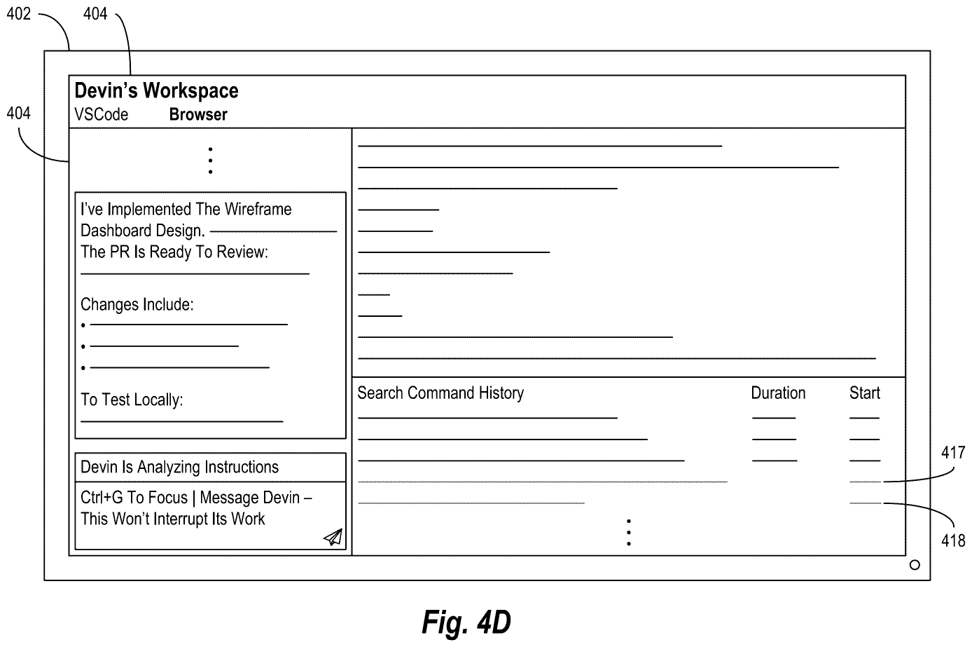

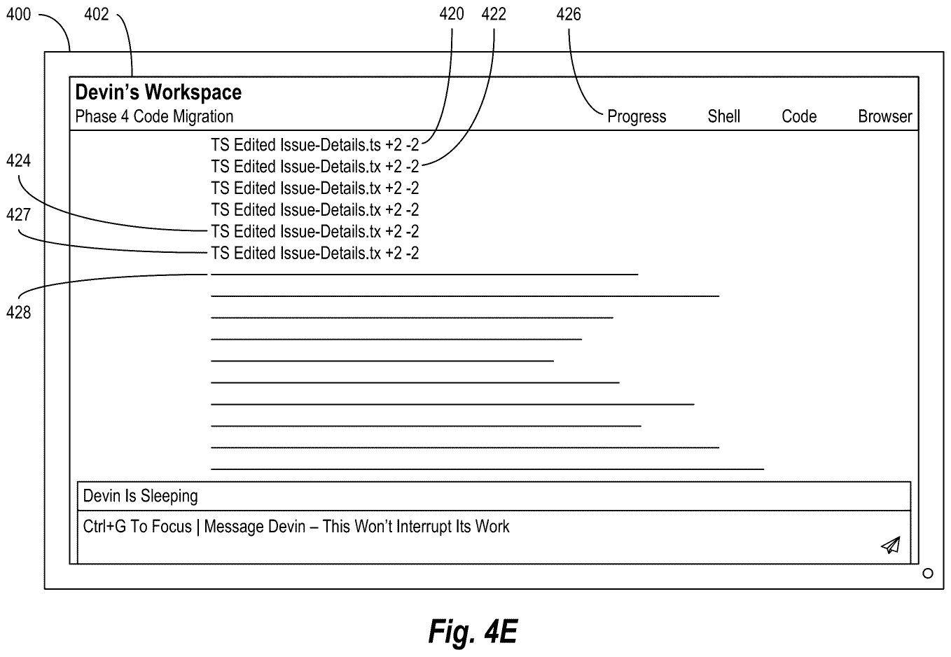

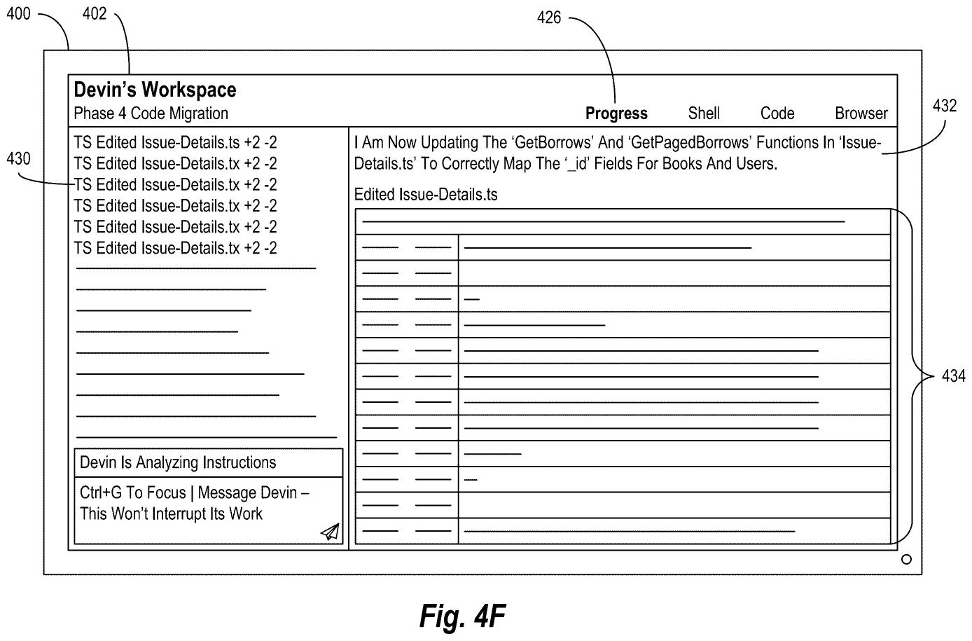

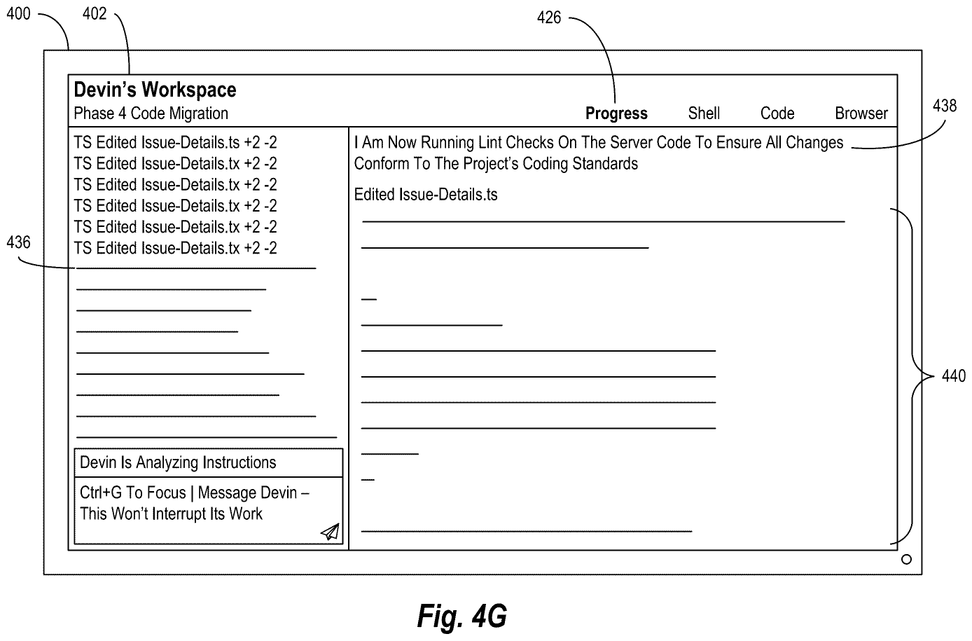

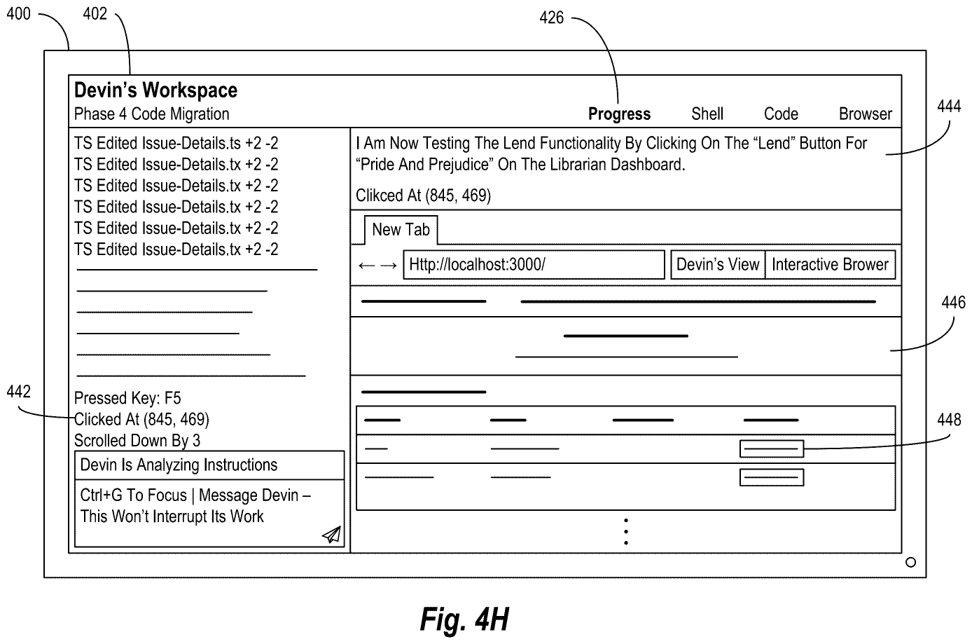

FIG. 4A illustrates the autonomous software agent system 100 providing a shell tool (or simply shell) and one or more options of using the shell tool in accordance with one or more embodiments. In one or more embodiments, the autonomous software agent system 100 accesses/receives a prompt and deploys an autonomous software agent in response to the prompt. For example, FIG. 4A shows the autonomous software agent system 100 providing a shell tool 400 to a graphical user interface of a user computing device. In particular, the shell tool 400 displayed at the graphical user interface of the user computing device can provide options such as viewing terminal commands 400a, output preview 400b, copy functionality 400c, time navigation 400d, integration with progress updates 400e, and usurping control 400f.

In some embodiments, the autonomous software agent system 100 provides the shell tool 400 to an autonomous software agent. In one or more embodiments, the shell tool 400 refers to one or more terminals (e.g., one or more terminal windows). In particular, the autonomous software agent system 100 deploys an autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool).

In some embodiments, the shell tool 400 is a text-based application where the autonomous software agent can input commands that interact directly with a computer's operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals.

In one or more embodiments, a shell tool refers to an interface layer that mediates interaction between an artificial intelligence (AI) agent and an underlying execution environment, computing system, development environment, or virtualized runtime. The shell tool provides a structured command, control, and input/output framework through which the autonomous software agent system 100 issues instructions, receives responses, and orchestrates software development operations. A shell tool may comprise a command-line interpreter, application programming interface (API) interface, remote procedure call (RPC) interface, messaging interface, terminal emulator, container interface, virtual machine interface, or any combination thereof. The shell tool abstracts underlying system resources-including file systems, process control, compilers, interpreters, debuggers, network interfaces, and package managers- and presents a controllable operational surface to the autonomous software agent system 100.

Furthermore, in some embodiments, the autonomous software agent system 100 performs an act of utilizing the autonomous software agent to generate terminal commands. In one or more embodiments, a terminal command refers to refers to text instructions to instruct a computer's operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent to interact with a computer system's underlying operating system or run scripts and programs directly). To illustrate, terminal commands can include file and directory navigation, file operations, viewing file contents, searching and filtering, processes and systems in an operating system, determining permissions and ownerships in an operating system, and networking. Accordingly, the autonomous software agent system 100 can provide an option for a user computing device to view the terminal commands 400a as they are submitted by an autonomous software agent.

Moreover, in some embodiments, the autonomous software agent system 100 generates command outputs. In one or more embodiments, command outputs refer to outputs that corresponds with the terminal commands 400a submitted via the shell tool 400. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, the autonomous software agent system 100 can provide an option for a user computing device to access the output preview 400b, which shows outputs corresponding with terminal commands. In addition, the autonomous software agent system 100 provides the copy functionality 400c for a user to copy the terminal commands and/or the outputs corresponding to the terminal commands.

Additionally, the autonomous software agent system 100 provides the time navigation 400d for a user computing device to jump between different points in a development session. In particular, the autonomous software agent system 100 can jump to a different point in a development session in response to a selection of a specific terminal command in the shell tool 400. Moreover, the autonomous software agent system 100 integrates the elements of the shell tool 400 within a progress interface (e.g., the integration with progress updates 400e) that is described in more detail below. Further, in some embodiments, the autonomous software agent system 100 provides the option for usurping control for a user computing device to usurp control of the shell tool 400 and for the user computing device to submit one or more terminal commands in place of an autonomous software agent.

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 400 while independently performing the software task. Accordingly, the user computing device (e.g., via the graphical user interface) can intervene (e.g., take over) the autonomous software agent's shell and push a software task in a different direction.

FIG. 4B shows the autonomous software agent system 100 providing for display on a graphical user interface 404 a shell tool being utilized by an autonomous software agent in accordance with one or more embodiments. For example, FIG. 4B shows a chat interface 406 between a user computing device 402 and the autonomous software agent system 100. In particular, the chat interface 406 shows a prompt of “I've implemented the wireframe dashboard design . . . the PR is ready for review . . . changes include . . . to test locally . . . ”

Moreover, FIG. 4B shows a terminal 408 of the shell tool that shows a search command history, a duration for running a terminal command, and a start time for the terminal command. Additionally, the terminal 408 display a plurality of terminal commands executed by the autonomous software agent system 100. FIG. 4C shows that within a terminal, the autonomous software agent system 100 provides various options for a specific terminal command in accordance with one or more embodiments.

For example, FIG. 4C shows a terminal command 410 and an open in progress option 412, a copy command option 414, and a copy output option 416. In particular, the open in progress option 412 indicates that a terminal command is in progress and the autonomous software agent system 100 is actively executing the terminal command. Furthermore, in response to a selection of the open in progress option 412, the autonomous software agent system 100 causes the graphical user interface to display steps being taken by the autonomous software agent system 100 to execute the in-progress terminal command.

Moreover, the copy command option 414 refers to the autonomous software agent system 100 copying the terminal command 410 to a clipboard of a user computing device. Furthermore, the copy output option 416 refers to the autonomous software agent system 100 copying an output corresponding to the terminal command 410 to the clipboard of a user computing device. Furthermore, FIG. 4D shows a first additional terminal command 417 and a second additional terminal command 418. As shown in FIG. 4D, the autonomous software agent system 100 shows the first additional terminal command 417 and the second additional terminal command 418 as greyed out, as the commands run at a future point in time within a development session. In some embodiments, the autonomous software agent system 100 allows a user computing device to jump to different points in time of a development session by clicking on different terminal commands shown in FIG. 4D.

FIG. 4E shows different steps in a development session within a progress interface of an autonomous software agent in accordance with one or more embodiments. For example, FIG. 4E shows a first step 420, a second step 422, a third step 424, a fourth step 427, and a fifth step 428 of the development session. Furthermore, FIG. 4E shows that a current view of the development session is depicted via a progress tab 426.

In one or more embodiments, the progress tab 426 unifies details of a development session. In particular, the autonomous software agent system 100 causes the progress tab 426 to present a unified view of shell commands, code edits, and browser activity as an autonomous software agent performs/executes a software task that is responsive to a prompt received from a user computing device.

FIG. 4F shows the autonomous software agent system 100 receiving a selection 430 of a specific step in the development session. In particular, in response to the selection 430, the autonomous software agent system 100 causes the graphical user interface to display details of the selected step. In particular, the autonomous software agent system 100 shows a description 432 of “I am now updating the ‘getBorrows’ and ‘getPagedBorrows’ functions in ‘issue-details.ts’ to correctly map the ‘_id’ fields for books and users.” Additionally, FIG. 4F shows relevant code 434 that relates to the specifically selected development step.

Likewise, FIG. 4G shows an additional example, of the autonomous software agent system 100 receiving a selection 436 of a step and providing for display details of the selected development step. In particular, FIG. 4G shows a description 438 of “I am now running lint checks on the server code to ensure all changes conform to the project's coding standards.” Additionally, FIG. 4G shows relevant code 440 that relates to the specifically selected development step.

FIG. 4H also shows an example of the autonomous software agent system 100 performing one or more website browsing actions. For example, FIG. 4H shows a development step 442 of “clicked at (845, 469)” and shows additional steps of “Pressed Key: F5” and “Scrolled down by 3.” Moreover, FIG. 4H shows a selection of the development step 442 and details of the selected development step on the right-hand interface. In particular, FIG. 4H shows a description 444 of “I am now testing the Lend functionality by clicking on the ‘Lend’ button for ‘Pride and Prejudice’ on the librarian dashboard.” Moreover, FIG. 4H shows a browser 446 and a click action 448 within the browser 446.

As mentioned above, the autonomous software agent system 100 can mirror actions to a graphical user interface of a user computing device based on an autonomous software agent utilizing an integrated development environment. For example, the autonomous software agent system 100 deploys an autonomous software agent and further enables options for a user computing device to interact, review, edit, and take over the autonomous software agent's work. To illustrate, in one or more embodiments, the autonomous software agent system deploys an autonomous software agent to independently complete software development tasks leveraging a fully featured, AI-enabled integrated development environment (IDE). In particular, the autonomous software agent system displays, via a graphical user interface on a user computing device, actions taken by the autonomous software agent while independently performing a software coding task.

In some embodiments, the autonomous software agent system provides options for a user computing device to switch between different levels of autonomy for the autonomous software agent executing a software coding task. For example, the autonomous software agent system enables a user computing device to continue to delegate entire tasks while the autonomous software agent is working completely asynchronously. Further, in some embodiments, the autonomous software agent system enables the user computing device to pair program live with the autonomous software agent in the IDE (e.g., using shortcuts and artificial intelligence features of an AI-native IDE), or work in a hybrid fashion (e.g., intervene and takeover/add finishing touches to the autonomous software agent's code before merging the generated code). In some embodiments, the autonomous software agent system is faster and more responsive to feedback provided by a user computing device (e.g., relative to existing systems) and understands changes made by the user computing device without being notified of those changes (e.g., during user intervention or pair programming).

Accordingly, the autonomous software agent system provides a wide range of latitudes for a user computing device working with an autonomous software agent (e.g., parallelization of hundreds of software coding tasks across a codebase). In other words, the autonomous software agent system enables a true work alongside experience between a user computing device and an autonomous software agent without the user computing device needing to be the “driver” for a software development task. In particular, as mentioned above, the autonomous software agent system innovates the user computing device-AI software agent interface by providing flexibility to seamlessly switch between different autonomy levels.

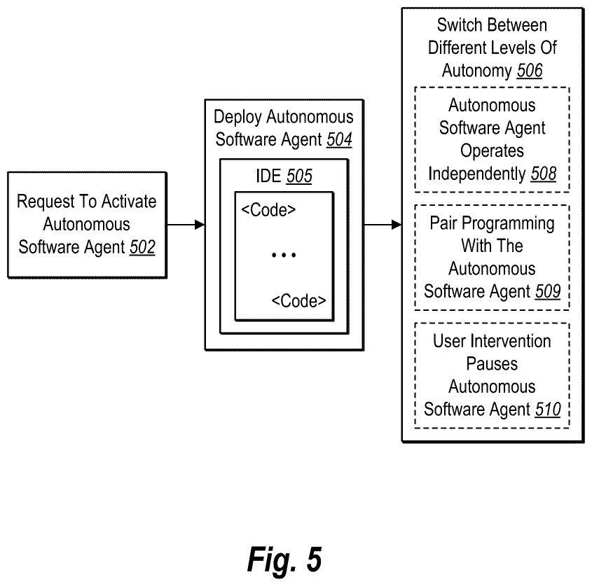

FIG. 5 illustrates an autonomous software agent system 100 deploying an autonomous software agent and enabling options to switch between different levels of autonomy in accordance with one or more embodiments. For example, FIG. 5 shows the autonomous software agent system 100 receiving a request 502 to activate an autonomous software agent 504. In one or more embodiments, the request 502 refers to a natural language prompt (from a user computing device). For example, the autonomous software agent system 100 can receive the request 502 as a natural language prompt via a web browser of the autonomous software agent system 100.

As shown in FIG. 5, in response to the request 502 to activate the autonomous software agent, the autonomous software agent system 100 performs an act of deploying an autonomous software agent 504. As further shown in FIG. 5, the autonomous software agent 504 includes an IDE 505 (e.g., integrated development environment).

As further shown in FIG. 5, the autonomous software agent system 100 enables options for a user computing device to perform an act 506 of seamlessly switching the autonomous software agent 504 to different levels of autonomy. In particular, FIG. 5 shows an option 508 of continuing to allow the autonomous software agent 504 to operate independently, an option 509 of a user computing device pair programming with the autonomous software agent 504, and an option 510 of user intervention (e.g., by the user computing device) to pause the autonomous software agent 504. Thus, the autonomous software agent system 100 enabling the options to switch between different levels of autonomy effectively allows a software developer to work on tens or hundreds of software development tasks across one or more codebases in parallel.

To illustrate, the autonomous software agent system 100 enables a software developer to effectively open an infinite number of windows in their IDE to work simultaneously on different tasks (e.g., via the autonomous software agent 504 operating in its own fully featured IDE). Accordingly, the autonomous software agent system 100 enables enhanced parallelization for faster feedback, review, and editing (e.g., relative to existing systems) by deploying the autonomous software agent 504 and allowing the user computing device to switch between different levels of autonomy.

In other words, the autonomous software agent system 100 enhances the parallelization of tasks by enabling an improved and viable workflow loop for faster feedback and review from a user computing device for work performed by the autonomous software agent and editing by the user computing device. In particular, due to the seamless ability to switch between different levels of autonomy for the autonomous software agent, the autonomous software agent system 100 provides a much more viable framework for leveraging autonomous software agents to simultaneously perform hundreds of complex non-trivial software coding tasks.

More specifically, in a fully autonomous mode, autonomous software agent system 100 independently decomposes, schedules, executes, validates, and refines software tasks using planner tool in coordination with the IDE, shell, and browser. This mode maximizes throughput and minimizes latency associated with human approval cycles. By eliminating synchronous user interaction during iterative debugging, compilation, and testing loops, the autonomous software agent system 100 reduces idle processor time and improves computational pipeline utilization. Fully autonomous operation is particularly advantageous for large, multi-step software tasks requiring repetitive validation cycles, as planner tool can dynamically replan based on structured execution feedback without awaiting external input.

In a supervised or user-intervention mode, autonomous software agent system 100 introduces defined control checkpoints at predetermined execution boundaries, such as prior to executing shell-level commands, modifying persistent repositories, accessing external network resources, or deploying artifacts. This controlled autonomy improves operational safety by preventing unintended state changes in sensitive environments. By enabling selective user approval of high-impact actions while permitting automated execution of low-risk subtasks, the autonomous software agent system 100 achieves a technically balanced control model that reduces security exposure without sacrificing automation efficiency.

The configurable autonomy framework further improves the autonomous software agent system 100 reliability through adaptive risk management. In one or more embodiments, the planner tool may dynamically adjust autonomy levels based on detected execution context, task complexity, system policy constraints, or confidence metrics derived from model outputs. For example, when structured diagnostics indicate high uncertainty or anomalous execution states, the autonomous software agent system 100 may automatically escalate to supervised mode. Conversely, when repetitive tasks exhibit consistent success patterns, the autonomous software agent system 100 may increase automation level. This adaptive autonomy improves fault tolerance and reduces cascading error propagation.

From a systems architecture perspective, multiple autonomy levels enable segmented execution control. High-privilege operations may require explicit confirmation, while low-privilege operations execute automatically within constrained resource limits. This layered control model enhances sandbox enforcement and prevents privilege escalation pathways that may arise during automated code generation and execution.

Configurable autonomy also improves auditability and traceability. In supervised modes, the autonomous software agent system 100 may generate structured action proposals prior to execution, enabling logging, versioning, and review of planned operations. This improves debugging transparency and facilitates deterministic replay of execution sequences.

Additionally, the availability of multiple autonomy levels enables more efficient allocation of human computational oversight resources. Rather than requiring continuous human supervision of all development steps, the autonomous software agent system 100, in one or more embodiments, confines human interaction to technically significant decision points. This reduces unnecessary interruption of automated processes while preserving oversight of high-impact operations.

In one or more embodiments, the multi-level autonomy architecture constitutes a technical control mechanism embedded within the autonomous software agent system 100 itself. In one or more embodiments, it modifies how processor instructions are scheduled, how execution privileges are granted, how system calls are issued through the shell interface, and how network interactions occur via the browser tool. The autonomy configuration therefore alters the operational behavior of the computing environment rather than merely adjusting a workflow or presentation layer. Accordingly, providing autonomous software agent system 100 with configurable levels of autonomy improves computational efficiency, execution safety, resource management, fault tolerance, and system diagnosability.

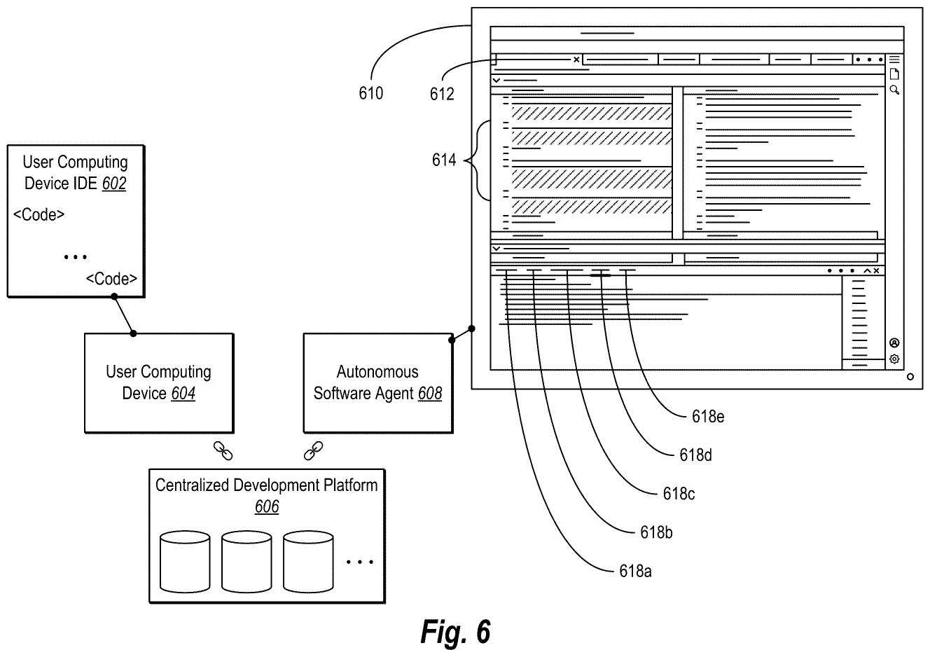

FIG. 6 illustrates the autonomous software agent system 100 deploying an autonomous software agent that operates alongside a user computing device in a centralized development platform in accordance with one or more embodiments. For example, FIG. 6 shows the autonomous software agent system 100 working alongside a user computing device 604 in a centralized development platform 606.

In one or more embodiments, the user computing device 604 refers to a device that interacts with computer systems, access code repositories, write computer code, and run applications. In particular, the user computing device 604 is typically operated by a user to perform the aforementioned acts. For example, the user computing device 604 can process data and perform various software coding tasks based on input received from a user.

In some embodiments, the user computing device 604 is part of the centralized development platform 606 (e.g., mentioned above) with a plurality of additional user computing devices. Moreover, in some embodiments, the centralized development platform 606 is also accessed by the autonomous software agent 608 (e.g., via access permissions granted to the autonomous software agent 608 by one or more user computing devices part of the centralized development platform 606).

In one or more embodiments, the centralized development platform 606 refers to a collaborative software environment where software developer computing devices (e.g., user computing devices) access, build, test, and deploy computer code software for a unified platform. In particular, the centralized development platform 606 can include source code, code repositories (e.g., code libraries), and code documentation. Moreover, when a software developer computing device adds/modifies computer code in the centralized development platform 606, the software developer computing device can track changes made to the code (e.g., leave comments).

In some embodiments, software applications/systems utilize one or more code repositories to organize computer code, collaborate on computer code projects, and maintain computer code over time. In other words, a code repository enables multiple software developer computing devices to collaborate on computer code projects (e.g., software development teams can upload and download changes to and from the code repository) by creating branches to work on specific features or computer code bugs. Once a branch is completed, software developer computing devices can merge their changes into the code repository (e.g., which results in other software developer computing devices with access to the code repository being able to access the changes).

As further shown in FIG. 6, the autonomous software agent system 100 provides the autonomous software agent 608 and the user computing device 604 with their own integrated development environment (IDE). In particular, FIG. 6 shows an integrated development environment 610 (IDE 610) for the autonomous software agent 608 and an integrated development environment 602 for the user computing device 604.

In some embodiments, an integrated development environment (IDE) refers to a software application that brings together software tools for software development into a unified graphical user interface. In particular, the integrated development environment refers to a software application that combines essential software development features (e.g., coding, debugging, testing, and deployment) to increase the efficiency of completing software projects.

The IDE may further maintain structured representations of a project state, including file hierarchies, dependency graphs, abstract syntax trees (ASTs), symbol tables, error diagnostics, execution traces, and build artifacts. In the context of the autonomous software agent system 100, the IDE is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment is a fully featured application that allows an autonomous software agent and/or a user computing device to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

Accordingly, the autonomous software agent system 100 provides the autonomous software agent 608 with its own fully featured IDE (e.g., independent of the integrated development environment 602 of the user computing device 604) to perform non-trivial software coding tasks. In other words, the autonomous software agent 608 has full access to the IDE 610, which enables the autonomous software agent 608 to complete complex software development tasks.

FIG. 6 shows the IDE 610 of the autonomous software agent 608 that includes an editor tab 612 (e.g., FIG. 6 shows multiple editor tabs which represent open files in an editor area of the IDE 610 for writing/editing computer code). In particular, the editor tab 612 corresponds to an open file. Further, FIG. 6 shows that for a relevant editor tab, the autonomous software agent 608 also has access to an editor 614 for writing/editing computer code.

Moreover, FIG. 6 shows a problems tab 618a (e.g., lists errors, warnings, and information for computer code (in the editor tab) to efficiently see errors in computer code or jump to problematic portions of computer code), an output tab 618b (e.g., shows logs and messages from the IDE 610 or extensions of the IDE to be notified of background activities like loading data onto a server or plugin operations), a debug console 618c (e.g., allows for interactions with a program during debugging, such as viewing runtime logs, evaluating expressions, or inspecting variables), a terminal 618d (e.g., a built-in shell/command-line interface for executing/submitting commands to a terminal, such as running scripts or installing packages), and a version control tab 618e (e.g., provides information as to which devices submitted changes to a code repository and why the changes were submitted to a code repository).

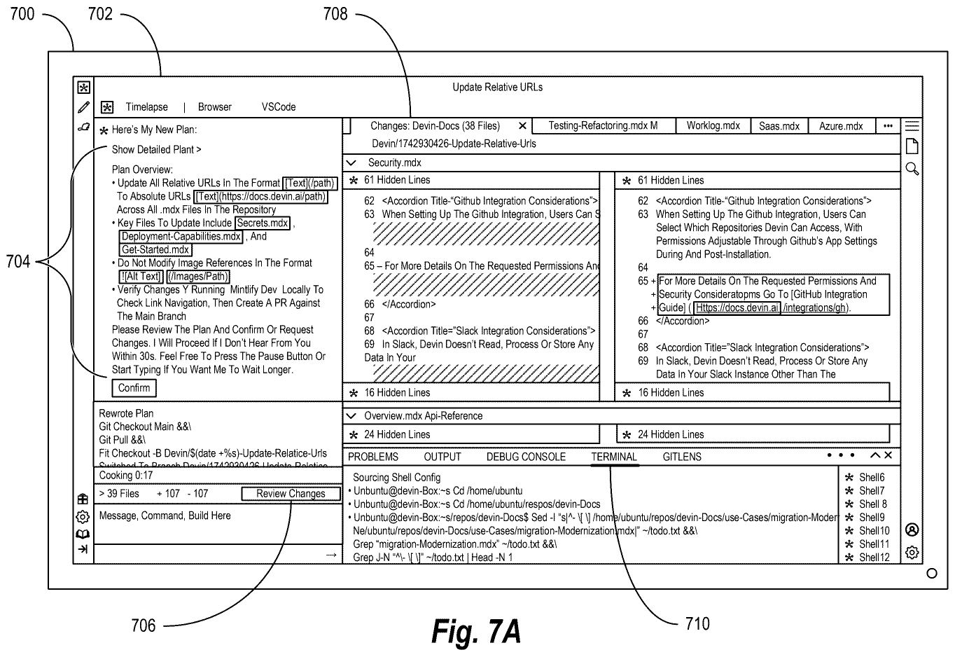

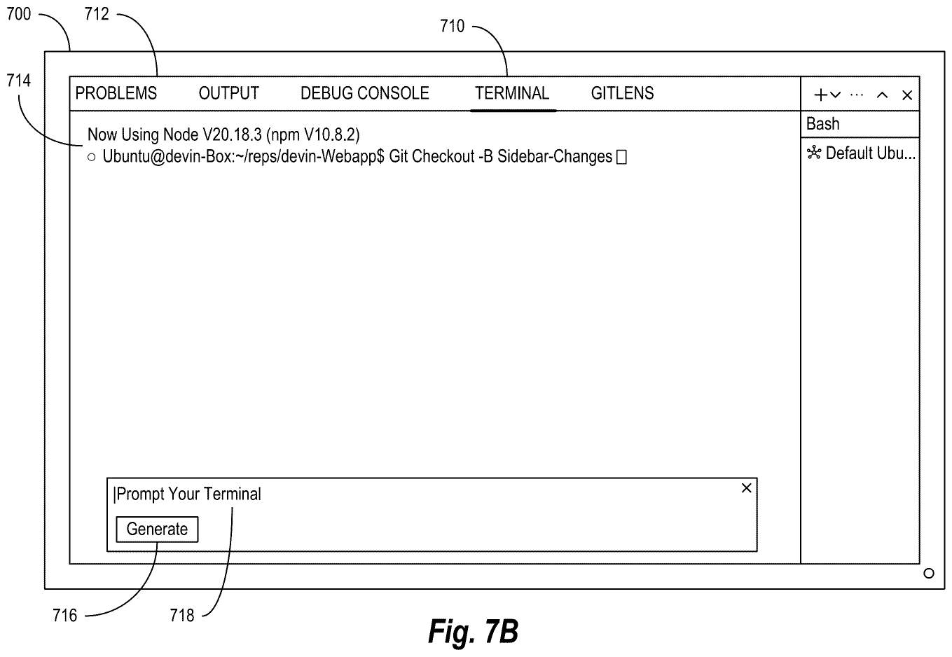

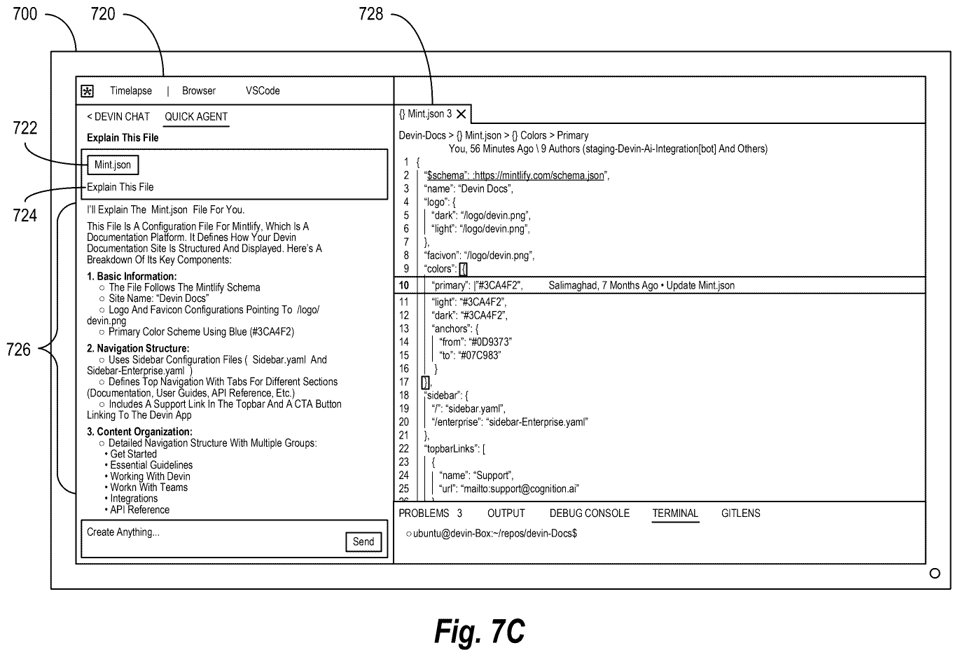

FIGS. 7A-7C illustrate example graphical user interfaces of a user computing device that display actions taken by the autonomous software agent in accordance with one or more embodiments. In some embodiments, FIGS. 7A-7C illustrates how the autonomous software agent system 100 allows a user computing device to pair program alongside the autonomous software agent and/or intervene in the software coding task of the autonomous software agent.

FIG. 7A illustrates a graphical user interface 702 on a user computing device 700 of an IDE (integrated development environment) that allows a user computing device to make edits and test the autonomous software agent's code directly in the autonomous software agent's IDE (e.g., directly access Devin's machine). In particular, FIG. 7A shows the autonomous software agent operating in an interactive IDE (e.g., interactive VSCode environment) loaded with code repositories of a centralized development platform.

For instance, FIG. 7A shows that the user computing device 700 can check in on the autonomous software agent's edits in real time (e.g., by selecting a graphical user interface element to follow the autonomous software agent), touch up the changes, or test the autonomous software agent's code directly using IDE tools and shortcuts.

Moreover, FIG. 7A shows that the fully featured IDE includes an editor tab 708 with multiple additional editor tabs for writing computer code for different files. In other words, FIG. 7A shows that the autonomous software agent system 100 can deploy an autonomous software agent to execute multiple software coding tasks in parallel (e.g., the autonomous software agent can open multiple tabs). Further, FIG. 7A shows how the user computing device 700 can follow (e.g., via the graphical user interface 702) the actions taken by the autonomous software agent.

As mentioned above, FIG. 7A shows the graphical user interface 702 of the user computing device 700. In one or more embodiments, the graphical user interface 702 refers to a screen of a user computing device. In other words, the graphical user interface refers to an interface that allows users to view and/or interact with a computing device.

In one or more embodiments, the graphical user interface 702 (e.g., the screen) refers to a visual part of a software application that allows a user of a computing device to interact with the software application. In particular, the autonomous software agent system 100 provides graphical user interfaces (e.g., screens) which allows a user of a computing device to interact with the software application through executable elements (e.g., buttons, menus, drop-downs, scrolling icons, windows).

In some embodiments, the autonomous software agent system 100 enables a user of a computing device to interact directly with a software application using a mouse, touchpad or touchscreen to select executable elements shown on a graphical user interface screen. In particular, the graphical user interface 702 can include visual elements such as icons (e.g., small pictures to represent programs), buttons (e.g., clickable elements), windows (e.g., displays content), menus (e.g., list of options or commands), text boxes, etc.

In some embodiments, the “graphical user interface on the user computing device” refers to the screen of the user computing device 700 (e.g., which a user can interact with via the user computing device). In particular, the graphical user interface 702 on the user computing device 700 can follow the autonomous software agent while it is writing computer code. For example, the graphical user interface 702 on the user computing device 700 can display the actions of the autonomous software agent by showing the integrated development environment of the autonomous software agent. In one or more embodiments, the graphical user interface 702 on the user computing device 700 shows actions taken by the autonomous software agent such as submitting terminal commands, using an editor to write computer code, accessing project files, compiling executable program code, etc.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, executable program code refers to a set of instructions that a computing device can directly execute. In particular, executable program code includes machine-readable instructions that result from compiling high-level programming languages. In other words, executable program code refers to a final output for a software development process created by compiling source code.

FIG. 7A shows on the graphical user interface 702 of the user computing device 700 a plan 704 (e.g., an artificial intelligence plan which was discussed above). In particular, the plan 704 illustrates how the autonomous software agent system 100 breaks down a request to deploy an autonomous software agent to perform a software coding task. As mentioned above, in some embodiments, the autonomous software agent system 100 utilizes a chain-of-thought reasoning model to break down a meta task (e.g., a request for a software coding task) into multiple discrete intermediate tasks. As illustrated in FIG. 7A, the plan 704 shows multiple sub steps.

To illustrate, FIG. 7A shows a plan overview of 1) updating all relative URLs in the format [Text] (/path) to absolute URLs [Text] (https://docs.devin.ai/path) across all mdx files in the repository, 2) updating key files to include secrets.mdx, deployment-capabilities.mdx, and get-started.mdx, 3) not modifying image references in the format! [Alt Text] (/ImagesPath), and 4) verify changes Y running Mintlify dev locally to check link navigation, then create a PR against the main branch. Moreover, the autonomous software agent system 100 provides an option for the user computing device to confirm the plan.

Furthermore, FIG. 7A shows an option to review changes 706. In particular, the option to review changes 706 allows a user computing device to receive a version history comparison of files (e.g., in the centralized development platform) before deployment of the autonomous software agent and after deployment of the autonomous software agent. In some embodiments, the option to review changes 706 includes a view in the graphical user interface 702 to see a different view of file edits that the autonomous software agent has made thus far (e.g., from time point A relative to time point B).

Moreover, in some embodiments, the autonomous software agent system 100 can send citations or references to computer code. In particular, the autonomous software agent system 100 can receive input from the user computing device 700 of a portion of computer code (e.g., in the editor). In response, the autonomous software agent system 100 can return deep links (e.g., citations or references that points directly to a specific piece of content within the IDE) to the computer code within the IDE of the autonomous software agent. Thus, FIG. 7A shows how the autonomous software agent system 100 enables a user computing device to submit prompts and follow actions taken by a deployed autonomous software agent all within a unified graphical user interface.

FIG. 7B shows additional details of the terminal 710 of the fully featured IDE of the autonomous software agent in accordance with one or more embodiments. For example, FIG. 7B shows a graphical user interface 712 of the user computing device 700 which further displays the terminal 710 of the autonomous software agent. In particular, FIG. 7B shows content 714 in the terminal 710 that includes natural language instructions input into the terminal 710 (e.g., now using node v20.18.3 (npm V10.8.2). To illustrate, the autonomous software agent system 100 can receive a shortcut (e.g., command+K) from the user computing device 700 and generate terminal commands (e.g., shown in FIG. 7B) from natural language.

Moreover, FIG. 7B shows a prompt input 718 to submit a prompt the terminal 710 and further shows a generate option 716 to generate instructions based on an input prompt. Thus, FIG. 7B illustrates how the autonomous software agent system 100 enables a user computing device to intervene in the IDE of the autonomous software agent, write prompts, and submit prompts on behalf of the autonomous software agent. As mentioned above, the user intervention is extremely effective for helping push difficult software coding tasks to completion that the autonomous software agent would not normally be able to one-shot.

FIG. 7C illustrates the autonomous software agent system 100 performing native AI functions in the IDE of the autonomous software agent in accordance with one or more embodiments. For example, FIG. 7C shows a graphical user interface 720 of the user computing device 700. In particular, FIG. 7C shows an editor tab 728 with written computer code (e.g., computer code written by the autonomous software agent) and also provides an option for the user computing device 700 to query the autonomous software agent system 100 about the written computer code.

As shown in FIG. 7C, the graphical user interface 720 shows the autonomous software agent system 100 receiving a query and providing a response to the query. For instance, FIG. 7C shows a query 724 of “explain this file” for an indicated file 722 (e.g., Mint.json). Moreover, FIG. 7C shows a response 726 to the query 724.

To illustrate, the autonomous software agent system 100 generates a response of “this file is a configuration file for Mintlify, which is a documentation platform. It defines how your Devin documentation site is structured and displayed . . . basic information: the file follows the Mintlify schema . . . navigation structure: uses sidebar configuration files . . . content organization: detailed navigation structure with multiple groups . . . ” Accordingly, FIG. 7C illustrates how the autonomous software agent system 100 enables a user computing device to pair program alongside the autonomous software agent to understand the context of the actions being taken by the autonomous software agent.

FIG. 8 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 8, the autonomous software agent system 100 contains a client layer 800 (e.g., with a web browser 802, an IDE extension 804, and a command line interface client 806), a frontend layer 808 with a load balancer 810 (e.g., which is a system to distribute incoming traffic across multiple servers which optimizes efficiency), a web application 812 (e.g., a Devin web application that shows a chat interface and the fully featured software composition tools of the autonomous software agent), and static assets 814 (e.g., files that do not dynamically change based on user interactions, such as HTML files, CSS files, JavaScript files, images, etc.).

Moreover, FIG. 8 shows the autonomous software agent system 100 also contains backend services 816 with an API gateway 818 (e.g., which is a single entry point for managing and routing API requests from client devices to different microservices/backend systems), a version control integration 820 (e.g., a backend service application to track changes to code such as a connected code repository application part of a code repository management system), a code analysis service 822, a project management service 824 (e.g., a software system to track the development of various tasks that a software development team is working on), a core AI service 826 (e.g., artificial intelligence modules or tools to handle the use of machine learning models, natural language processing, and other artificial intelligence tasks), and an authentication service 828 (e.g., to check for valid authentication credentials).

In particular, the backend services 816 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 816 of the autonomous software agent system 100 manages the generation of artificial intelligence outputs for executing a software task of a development session.

For example, the backend services 816 perform the job of enabling request decomposition, artificial intelligence plan generation, terminal command generation, computer code generation, navigation actions, software task orchestration, and interactive tools of the autonomous software agent. In particular, the client layer 800, the frontend layer 808 and the backend services 816 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 8 shows a data layer 830 with object storage 832 (e.g., which is storage of unstructured data), a search index 834 (e.g., an index of one or more code repositories), a cache layer 836 (e.g., a layer that temporarily holds frequently accessed or recently computed data), and a primary database 838 (e.g., a central data store to hold application data). Moreover, FIG. 8 shows an AI layer 840 with a code understanding model 842, an LLM engine 844, and a code generation model 846. Moreover, FIG. 8 shows a development operations and monitoring layer 848 (e.g., with metrics collection 850, an alert system 851, and a logging system 852).

As shown in FIG. 8, the autonomous software agent system 100 utilizes the AI layer 840 to perform a variety of reasoning/generation tasks. In particular, the autonomous software agent system 100 accesses the AI layer 840 every time a code repository is connected or updated, or a new session is spun up (e.g., each time a new development box is activated). In order to enable the AI layer 840, the autonomous software agent system 100 provides various onboarding tools to a user computing device. In particular the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 8, the AI layer 840 of the autonomous software agent system 100 further includes the code understanding model 842. In particular, the code understanding model 842 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 842. To illustrate, the autonomous software agent system 100 parses through a code repository and generates abstraction summaries using the code understanding model 842 and one or more additional artificial intelligence models (e.g., such as the LLM engine).

Moreover, the autonomous software agent system 100 utilizes the AI layer 840 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 840 to ingest data from a code base and further utilizes the code understanding model 842 to generate output predictions related to context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 842 of the autonomous software agent system 100. In addition, after generating the index of the code repository, the autonomous software agent system 100 further stores the index in the data layer 830 and/or uses the development operations and monitoring layer 848 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates responses to prompts. In some embodiments, the autonomous software agent system 100 receives prompts from the frontend layer 808 submitted via an interface (or where the autonomous software agent system 100 intakes prompts, whether via the web application, a messaging application, or otherwise) and are sent to the backend services 816 of the autonomous software agent system 100, where the prompt is processed by the one or more artificial intelligence components (e.g., Devin's brain).

As shown in FIG. 8, the autonomous software agent system 100 utilizes the client layer 800 to receive interactions. In particular, users can submit a prompt of a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and to further create sessions by tagging an autonomous software agent in their team's messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 844 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 8. In particular, the autonomous software agent system 100 includes a natural language processing component (e.g., Devin's Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in application Ser. No. 19/224,222 PROVIDING INTELLIGENT SEARCH FUNCTIONALITY OF A CODE REPOSITORY VIA AN AUTONOMOUS SOFTWARE AGENT which was filed on May 30, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge is a form of “memory” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user's workspace (e.g., Devin's Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In running back to an earlier point in time, the autonomous software agent system 100 rolls back both the state of “Devin's brain” (e.g., the knowledge and the progress on a certain task), as well as the state of Devin's machine (e.g., the machine contents).

Moreover, in some embodiments, the autonomous software agent system 100 offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 840, the data layer 830, the backend services 816, and the frontend layer 808 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 846. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

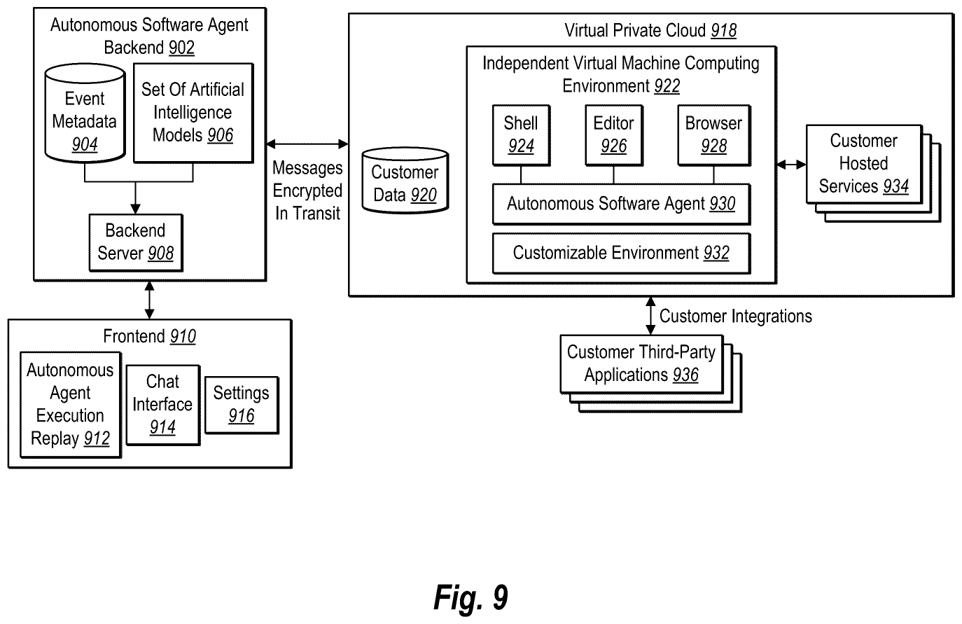

FIG. 9 illustrates additional details of the architecture of the autonomous software agent system 100 in accordance with one or more embodiments. For example, FIG. 9 shows that for each session of deploying an autonomous software agent, the autonomous software agent system 100 spins up/deploys an autonomous software agent backend 902 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 906. As mentioned above, the set of artificial intelligence models 906 contains one or more machine learning/artificial intelligence models shown above used to process, analyze, and generate data.

As shown in FIG. 9, the autonomous software agent backend 902 includes event metadata 904 (e.g., context surrounding a prompt/request submitted to a web application interface, a response to the prompt, or other external sources that contain contextual data), the set of artificial intelligence models 906 (e.g., one or more machine learning models shown and discussed in FIG. 8), and a backend server 908 (e.g., a server that handles logic, database interactions, authentication, and other services for deploying an autonomous software agent).

Further, FIG. 9 shows the autonomous software agent backend 902 interacting with a frontend 910 which includes autonomous agent execution replay 912 (e.g., replay for a timelapse of a development session, a session replay that is a recording of previous user interactions with the autonomous software agent system 100), chat UI 914 (e.g., the graphical user interface provided to a user to submit prompts), and settings 916 (e.g., custom settings established by the autonomous software agent system 100 or by a user).

Moreover, the autonomous software agent backend 902 communicates with a virtual private cloud 918 (e.g., a customer virtual private cloud, which is a dedicated and isolated virtual network within a public cloud service) via encrypted messages. In particular, FIG. 9 shows an independent virtual machine computing environment 922 hosted on the virtual private cloud 918 and the virtual private cloud 918 further includes customer data 920.

Additionally, the independent virtual machine computing environment 922 further includes a shell 924, an editor 926 (e.g., integrated development environment), a browser 928, an autonomous software agent 930, a customizable environment 932 (e.g., playbooks, knowledge, etc. that customize an independent virtual machine computing environment) and customer hosted services 934 (e.g., services or applications hosted and managed by a tenant organization). Additionally, FIG. 9 shows that the virtual private cloud 918 can integrate various applications via access tokens/API keys. In particular, the autonomous software agent system can use the independent virtual machine computing environment 922 (e.g., the autonomous software agent) to write various code and make integrations with applications integrated with the virtual private cloud 918 (e.g., customer third-party applications 936).

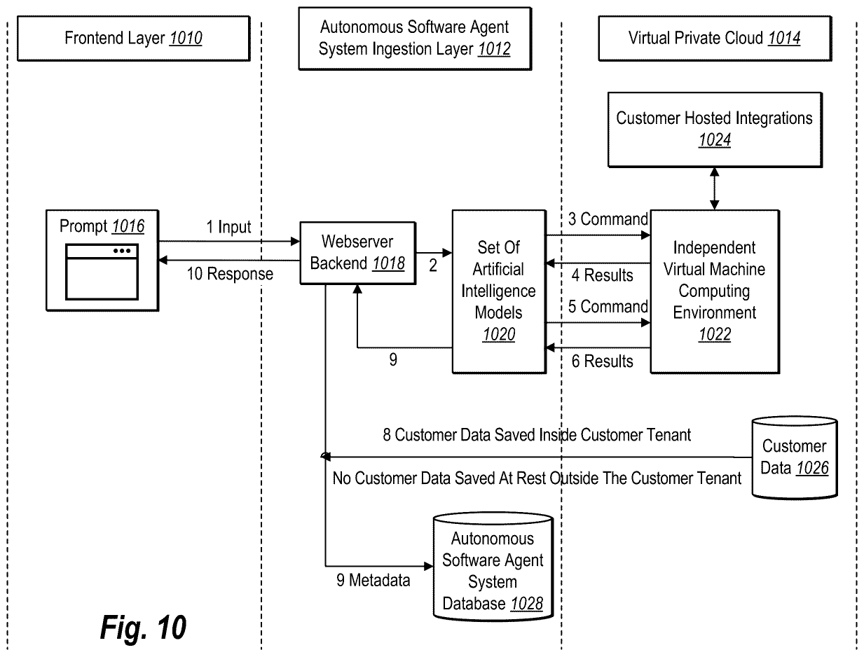

Further, FIG. 10 shows that the autonomous software agent system 100 receives a prompt 1016 via a frontend layer 1010. As shown, the autonomous software agent system 100 passes the prompt 1016 to an autonomous software agent system ingestion layer 1012. In response to the prompt 1016, the autonomous software agent system 100 responds to the prompt 1016 with a webserver backend 1018 and further passes the information to a set of artificial intelligence models 1020 (e.g., one or more artificial intelligence models shown above in FIG. 8).

As further shown in FIG. 10, the autonomous software agent system 100 passes commands/results back and forth between a virtual private cloud 1014 (e.g., an independent virtual machine computing environment 1022) and the set of artificial intelligence models 1020. In other words, FIG. 10 illustrates the interaction between the frontend layer 1010 of the autonomous software agent system 100, the backend of the autonomous software agent system 100, and an autonomous software agent deployed for performing tasks at the virtual private cloud 1014. Furthermore, the independent virtual machine computing environment 1022 also accesses customer hosted integrations 1024 at the virtual private cloud 1014.

Additionally, FIG. 10 shows customer data 1026 at the virtual private cloud 1014 which the autonomous software agent system 100 passes all customer data saved inside customer tenant to the tenant (e.g., and no customer data is saved at rest outside the customer tenant). Moreover, FIG. 10 shows the autonomous software agent system 100 using the webserver backend 1018 to pass metadata to an autonomous software agent system database 1028.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 1022 to communicate with the set of artificial intelligence models 1020 (e.g., the artificial intelligence components shown in FIG. 8) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 8-10, in one or more embodiments, the autonomous software agent system trains the set of artificial intelligence models 1020 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 1020 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 1020). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 9-10 describe various architectural details of the autonomous software agent system 100. In particular, the architectural components of the autonomous software agent system 100 enables an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

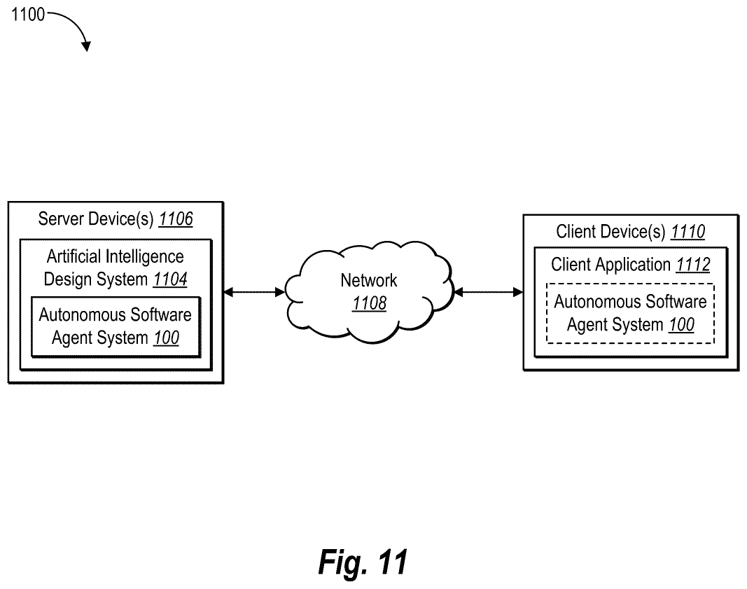

Additional details regarding the autonomous software agent system 100 will now be provided with reference to the figures. For example, FIG. 11 illustrates a schematic diagram of an exemplary system environment 1100 in which an autonomous software agent system 100 operates. As illustrated in FIG. 11, the system environment 1100 includes server device(s) 1106, an artificial intelligence design system 1104, a network 1108, and client device(s) 1110. Additionally, FIG. 11 illustrates that the artificial intelligence design system 1104 includes the autonomous software agent system 100.

Although the system environment 1100 of FIG. 11 is depicted as having a particular number of components, the system environment 1100 is capable of having a different number of additional or alternative components (e.g., a different number of servers, client devices, or other components in communication with the autonomous software agent system 100 via the network 1108). Similarly, although FIG. 11 illustrates a particular arrangement of the server device(s) 1106, the network 1108, and the client device(s) 1110, various additional arrangements are possible.

The server device(s) 1106, the network 1108, and the client device(s) 1110 are communicatively coupled with each other either directly or indirectly (e.g., through the network 1108 discussed in greater detail below). Moreover, the server device(s) 1106 and the client device(s) 1110 include one or more of a variety of computing devices (including one or more computing devices as discussed in greater detail below).

As mentioned above, the system environment 1100 includes the server device(s) 1106. In one or more embodiments, the server device(s) 1106 process input for a request (e.g., a request to configure an autonomous software agent or to deploy an autonomous software agent). In one or more embodiments, the server device(s) 1106 comprise a data server. In some implementations, the server device(s) 1106 comprise a communication server or a web-hosting server. Furthermore, the server device(s) 1106 can be associated with the autonomous software agent system 100 or with an organization/company that deploys the autonomous software agent system 100.

In some embodiments, the client device(s) 1110 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1110 includes smartphones, tablets, desktop computers, laptop computers, head-mounted-display devices, or other electronic devices. The client device(s) 1110 includes one or more software applications (e.g., the client application 1112) for generating content in accordance with the artificial intelligence design system 1104. In one or more embodiments, the client application 1112 includes a software application hosted on the server device(s) 1106 accessible by the client device(s) 1110 through another application, such as a web browser.

To provide an example implementation, in some embodiments, the autonomous software agent system 100 on the server device(s) 1106 supports the autonomous software agent system 100 on the client device(s) 1110. For instance, in some cases, the artificial intelligence design system 1104 on the server device(s) 1106 gathers data for the autonomous software agent system 100. In response, the autonomous software agent system 100, via the server device(s) 1106, provides the information to the client device(s) 1110. In other words, the client device(s) 1110 obtains (e.g., downloads) the autonomous software agent system 100 from the server device(s) 1106 that is already trained/optimized. Once downloaded, the autonomous software agent system 100 on the client device(s) 1110 is able to perform tasks (e.g., generative software tasks) independent from the server device(s) 1106. In one or more alternative implementations, the autonomous software agent system 100 generates or learns parameters for one or more artificial intelligence models (e.g., used to implement an autonomous software agent) in whole or in part on the client device(s) 1110.

In alternative implementations, the artificial intelligence design system 1104 includes a web hosting application that allows the client device(s) 1110 to interact with content and services hosted on the server device(s) 1106. To illustrate, in one or more implementations, the client device(s) 1110 accesses a software application supported by the server device(s) 1106. In response, the artificial intelligence design system 1104 on the server device(s) 1106 provides tools for monitoring/modifying/generating computer code using the autonomous software agent. In other words, the client device(s) 1110 does not have to download the autonomous software agent system 100 while still being able to access/utilize the trained/optimized tools provided by the artificial intelligence design system 1104 via a web hosting application.

In some embodiments, the autonomous software agent system 100 is implemented in whole, or in part, by the individual elements of the system environment 1100. For instance, although FIG. 11 illustrates the autonomous software agent system 100 implemented or hosted on the server device(s) 1106, different components of the autonomous software agent system 100 are able to be implemented by a variety of devices within the system environment 1100. For example, one or more (or all) components of the autonomous software agent system 100 are implemented by a different computing device or a separate server from the server device(s) 1106. Indeed, as shown in FIG. 11, the client device(s) 1110 includes the autonomous software agent system 100.

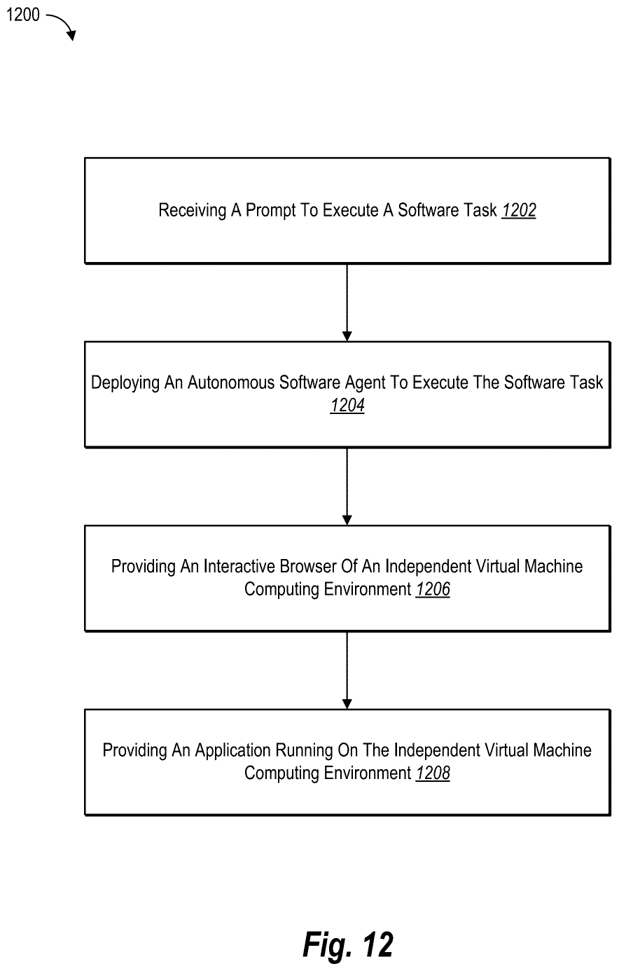

FIG. 12 illustrates a flowchart of a series of acts 1200 for providing an interactive browser to a graphical user interface in accordance with one or more embodiments. FIG. 12 illustrates acts according to one embodiment, alternative embodiments may omit, add to, reorder, and/or modify any of the acts shown in FIG. 12. In some implementations, the acts of FIG. 12 are performed as part of a method. For example, in some embodiments, the acts of FIG. 12 are performed as part of a computer-implemented method. Alternatively, a non-transitory computer-readable medium stores instructions thereon that, when executed by at least one processor, cause a computing device to perform the acts of FIG. 12. In some embodiments, a system performs the acts of FIG. 12. For example, in one or more embodiments, a system includes at least one memory device. The system further includes at least one server device configured to cause the system to perform the acts of FIG. 12.

The series of acts 1200 includes an act 1202 of receiving a prompt to execute a software task. Further, the series of acts 1200 includes an act 1204 of deploying an autonomous software agent to execute the software task. Moreover, the series of acts 1200 includes an act 1206 of providing an interactive browser of an independent virtual machine computing environment. Furthermore, the series of acts 1200 includes an act 1208 of providing an application running on the independent virtual machine computing environment.

In particular, the act 1202 includes receiving, via a graphical user interface, a prompt to execute a software task. Further, the act 1204 includes deploying an autonomous software agent to execute the software task in an independent virtual machine computing environment. Moreover, the act 1206 includes providing, for display in the graphical user interface, an interactive browser of the independent virtual machine computing environment. Additionally, the act 1208 includes providing, for display in the interactive browser, an application running on the independent virtual machine computing environment, the application being generated or modified by the autonomous software agent as part of executing the software task. The series of acts 1200 further includes the below clauses.

Clause 1. A computer-implemented method comprising: receiving, via a graphical user interface, a prompt to execute a software task; deploying an autonomous software agent to execute the software task in an independent virtual machine computing environment; providing, for display in the graphical user interface, an interactive browser of the independent virtual machine computing environment; and providing, for display in the interactive browser, an application running on the independent virtual machine computing environment, the application being generated or modified by the autonomous software agent as part of executing the software task.

Clause 2. The computer-implemented method of clause 1, further comprising: providing, for display in the interactive browser, an interactive browser option element to usurp browser control of the interactive browser from the autonomous software agent in the independent virtual machine computing environment; and in response to a selection of the interactive browser option element, cede browser control of the application running on the independent virtual machine computing environment to a computing device controlled by a user.

Clause 3. The computer-implemented method of any of clauses 1-2, further comprising: receiving, via the graphical user interface, one or more additional website browsing actions to assist the autonomous software agent in executing the software task; providing, via the graphical user interface, a browser control release option element; receiving, via the graphical user interface, a selection of the browser control release option element; and resuming an execution of the software task based on the one or more additional website browsing actions.

Clause 4. The computer-implemented method of any of clauses 1-3, further comprising: providing, for display in the interactive browser, a user interface of the application running on the independent virtual machine computing environment; providing, for display in an interactive integrated development environment interface of the graphical user interface, an integrated development environment option element to usurp control of an integrated development environment from the autonomous software agent in the independent virtual machine computing environment; and in response to a selection of the integrated development environment option element, cede control of the integrated development environment on the independent virtual machine computing environment to a computing device controlled by a user.

Clause 5. The computer-implemented method of any of clauses 1-4, further comprising receiving, from the computing device controlled by the user, one or more modifications to stylistic user interface computer code written in the integrated development environment by the autonomous software agent.

Clause 6. The computer-implemented method of any of clauses 1-5, further comprising: providing, for display in the interactive browser, the autonomous software agent encountering an authentication challenge designed for a human; providing, for display in the interactive browser, an interactive browser option element to usurp browser control of the interactive browser from the autonomous software agent in the independent virtual machine computing environment; and in response to a selection of the interactive browser option element, cede browser control of the application running on the independent virtual machine computing environment to a computing device controlled by a user.

Clause 7. The computer-implemented method of any of clauses 1-6, further comprising: receiving, from the computing device controlled by the user, user input to resolve the authentication challenge designed for the human; receiving, via the graphical user interface, a selection of a browser control release option element; and resuming an execution of the software task based on receiving the user input to resolve the authentication challenge.

Clause 8. The computer-implemented method of any of clauses 1-7, further comprising: providing for display in the graphical user interface, a progress interface to follow a progress of the autonomous software agent executing the software task; providing, for display in the graphical user interface, an interactive shell interface of the independent virtual machine computing environment; and providing, for display in the graphical user interface, an interactive integrated development environment interface of the independent virtual machine computing environment.

Clause 9. A system comprising: one or more memory devices; and one or more processors coupled to the one or more memory devices, configured to cause the system to: receive, via a graphical user interface, a prompt to execute a software task by utilizing an autonomous software agent in an independent virtual machine computing environment; provide, for display in the graphical user interface, an interactive browser of the independent virtual machine computing environment through which the autonomous software agent performs one or more web-based tasks as part of executing the software task; provide, for display in the graphical user interface, an interactive browser option element to usurp browser control from the autonomous software agent in the independent virtual machine computing environment; in response to a selection of the interactive browser option element, cede browser control to a computing device controlled by a user; and receive, via the graphical user interface, one or more additional website browsing actions to assist the autonomous software agent in executing the software task.

Clause 10. The system of clause 9, wherein the one or more processors are configured to cause the system to: in response to the prompt to execute the software task, generate an artificial intelligence plan; provide, for display in the graphical user interface, the artificial intelligence plan; and provide, for display in the graphical user interface a confirm element and a modification element for a user to confirm or modify the artificial intelligence plan.

Clause 11. The system of any of clauses 9-10, wherein the one or more processors are configured to cause the system to generate the artificial intelligence plan by: identifying, utilizing a large language model, relevant files to execute the software task; identifying, utilizing the large language model, key findings to execute the software task; and identifying, utilizing the large language model, implementation questions to execute the software task.

Clause 12. The system of any of clauses 9-11, wherein the one or more processors are configured to cause the system to: determine a multi-factor authentication as the autonomous software agent performs the one or more web-based tasks as part of executing the software task; and receive, from the computing device controlled by the user, a multi-factor authentication input.

Clause 13. The system of any of clauses 9-12, wherein the one or more processors are configured to cause the system to: receive, via the graphical user interface, a selection of a browser control release option element; and resume an execution of the software task in response to the selection of the browser control release option element.

Clause 14. The system of any of clauses 9-13, wherein the one or more processors are configured to cause the system to: provide, for display in the interactive browser, a user interface of an application running on the independent virtual machine computing environment; and provide, for display in an interactive integrated development environment interface of the graphical user interface, an integrated development environment option element to usurp control of an integrated development environment from the autonomous software agent in the independent virtual machine computing environment.

Clause 15. The system of any of clauses 9-14, wherein the one or more processors are configured to cause the system to: in response to a selection of the integrated development environment option element, cede control of the integrated development environment on the independent virtual machine computing environment to a computing device controlled by a user; receive, from the computing device controlled by the user, one or more modifications to stylistic user interface computer code written in the integrated development environment; receive a selection from the computing device controlled by the user to switch to the interactive browser; and provide, for display in the interactive browser, the user interface of the application, wherein the user interface is displayed according to the one or more modifications to the stylistic user interface computer code.

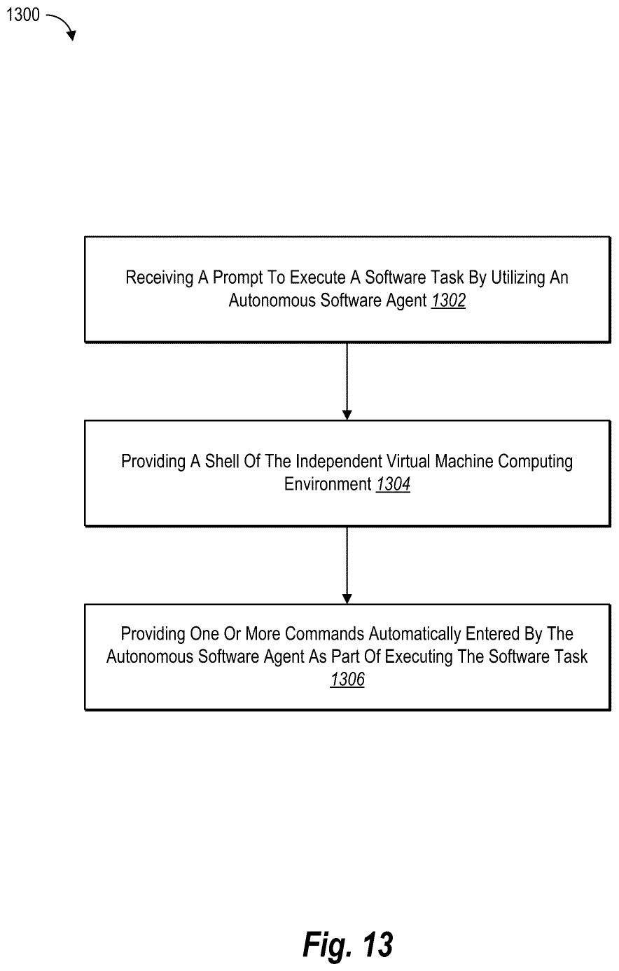

FIG. 13 illustrates a flowchart of a series of acts 1300 for providing a shell of an independent virtual machine computing environment to a graphical user interface in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium stores instructions thereon that, when executed by at least one processor, cause a computing device to perform the acts of FIG. 13. In some embodiments, a system performs the acts of FIG. 13. For example, in one or more embodiments, a system includes at least one memory device. The system further includes at least one server device configured to cause the system to perform the acts of FIG. 13.

The series of acts 1300 includes an act 1302 of receiving a prompt to execute a software task by utilizing an autonomous software agent. Further, the series of acts 1300 includes an act 1304 of providing a shell of the independent virtual machine computing environment. Moreover, the series of acts 1300 includes an act 1306 of providing one or more commands automatically entered by the autonomous software agent as part of executing the software task.

In particular, the act 1302 includes receiving, via a graphical user interface, a prompt to execute a software task by utilizing an autonomous software agent in an independent virtual machine computing environment. Further, the act 1304 includes providing, for display in the graphical user interface, a shell of the independent virtual machine computing environment. Moreover, the act 1306 includes providing, for display in the shell, one or more commands automatically entered by the autonomous software agent as part of executing the software task. The series of acts 1300 further includes the below clauses.

Clause 16. A non-transitory computer-readable medium storing executable instructions which, when executed by at least one processing device, cause the at least one processing device to perform operations comprising: receiving, via a graphical user interface, a prompt to execute a software task by utilizing an autonomous software agent in an independent virtual machine computing environment; providing, for display in the graphical user interface, a shell of the independent virtual machine computing environment; and providing, for display in the shell, one or more commands automatically entered by the autonomous software agent as part of executing the software task.

Clause 17. The non-transitory computer-readable medium of clause 16, wherein providing the one or more commands automatically entered further comprises: providing, for display in the shell, in-progress terminal commands from the autonomous software agent executing the software task; and providing, for display in the shell, one or more outputs corresponding to the one or more commands automatically entered by the autonomous software agent.

Clause 18. The non-transitory computer-readable medium of any of clauses 16-17, wherein providing the one or more commands automatically entered further comprises: providing, for display in the shell, an option to copy a command entered by the autonomous software agent; and providing, for display in the shell, an option to copy an output corresponding to the command entered by the autonomous software agent.

Clause 19. The non-transitory computer-readable medium of any of clauses 16-18, further comprising: providing, via the graphical user interface, a progress interface to follow a progress of the autonomous software agent executing the software task, wherein the progress interface depicts shell commands, code edits, and browser activity.

Clause 20. The non-transitory computer-readable medium of any of clauses 16-19, further comprising: providing, via the progress interface, a plurality of steps within a development session from the autonomous software agent executing the software task; receiving, via the progress interface, a selection of a step of the plurality of steps; and providing, via the progress interface, an expanded view of the step that depicts details of the step that was executed or is being executed by the autonomous software agent.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates a block diagram of an example computing device 1400 that may be configured to perform one or more of the processes described above. One will appreciate that one or more computing devices, such as the computing device 1400 may represent the computing devices described above (e.g., the server device(s) 1106 and/or the client device(s) 1110). In one or more embodiments, the computing device 1400 may be a mobile device (e.g., a mobile telephone, a smartphone, a PDA, a tablet, a laptop, a camera, a tracker, a watch, a wearable device). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 include hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 including storage for storing data or instructions. As an example, and not by way of limitation, the storage device 1406 can include a non-transitory storage medium described above. The storage device 1406 may include a hard disk drive (HDD), flash memory, a Universal Serial Bus (USB) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can include hardware, software, or both that connects components of computing device 1400 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
receiving, via a graphical user interface, a prompt to execute a software task;
deploying an autonomous software agent to execute the software task in an independent virtual machine computing environment;
providing, for display in the graphical user interface, an interactive browser of the independent virtual machine computing environment; and
providing, for display in the interactive browser, an application running on the independent virtual machine computing environment, the application being generated or modified by the autonomous software agent as part of executing the software task.

2. The computer-implemented method of claim 1, further comprising:
providing, for display in the interactive browser, an interactive browser option element to usurp browser control of the interactive browser from the autonomous software agent in the independent virtual machine computing environment; and
in response to a selection of the interactive browser option element, cede browser control of the application running on the independent virtual machine computing environment to a computing device controlled by a user.

3. The computer-implemented method of claim 2, further comprising:
receiving, via the graphical user interface, one or more additional website browsing actions to assist the autonomous software agent in executing the software task;
providing, via the graphical user interface, a browser control release option element;
receiving, via the graphical user interface, a selection of the browser control release option element; and
resuming an execution of the software task based on the one or more additional website browsing actions.

4. The computer-implemented method of claim 1, further comprising:
providing, for display in the interactive browser, a user interface of the application running on the independent virtual machine computing environment;
providing, for display in an interactive integrated development environment interface of the graphical user interface, an integrated development environment option element to usurp control of an integrated development environment from the autonomous software agent in the independent virtual machine computing environment; and
in response to a selection of the integrated development environment option element, cede control of the integrated development environment on the independent virtual machine computing environment to a computing device controlled by a user.

5. The computer-implemented method of claim 4, further comprising receiving, from the computing device controlled by the user, one or more modifications to stylistic user interface computer code written in the integrated development environment by the autonomous software agent.

6. The computer-implemented method of claim 1, further comprising:
providing, for display in the interactive browser, the autonomous software agent encountering an authentication challenge designed for a human;
providing, for display in the interactive browser, an interactive browser option element to usurp browser control of the interactive browser from the autonomous software agent in the independent virtual machine computing environment; and
in response to a selection of the interactive browser option element, cede browser control of the application running on the independent virtual machine computing environment to a computing device controlled by a user.

7. The computer-implemented method of claim 6, further comprising:
receiving, from the computing device controlled by the user, user input to resolve the authentication challenge designed for the human;
receiving, via the graphical user interface, a selection of a browser control release option element; and
resuming an execution of the software task based on receiving the user input to resolve the authentication challenge.

8. The computer-implemented method of claim 1, further comprising:
providing for display in the graphical user interface, a progress interface to follow a progress of the autonomous software agent executing the software task;
providing, for display in the graphical user interface, an interactive shell interface of the independent virtual machine computing environment; and
providing, for display in the graphical user interface, an interactive integrated development environment interface of the independent virtual machine computing environment.

9. A system comprising:
one or more memory devices; and
one or more processors coupled to the one or more memory devices, configured to cause the system to:
receive, via a graphical user interface, a prompt to execute a software task by utilizing an autonomous software agent in an independent virtual machine computing environment;
provide, for display in the graphical user interface, an interactive browser of the independent virtual machine computing environment through which the autonomous software agent performs one or more web-based tasks as part of executing the software task;
provide, for display in the graphical user interface, an interactive browser option element to usurp browser control from the autonomous software agent in the independent virtual machine computing environment;
in response to a selection of the interactive browser option element, cede browser control to a computing device controlled by a user; and
receive, via the graphical user interface, one or more additional website browsing actions to assist the autonomous software agent in executing the software task.

10. The system of claim 9, wherein the one or more processors are configured to cause the system to:
in response to the prompt to execute the software task, generate an artificial intelligence plan;
provide, for display in the graphical user interface, the artificial intelligence plan; and
provide, for display in the graphical user interface a confirm element and a modification element for a user to confirm or modify the artificial intelligence plan.

11. The system of claim 10, wherein the one or more processors are configured to cause the system to generate the artificial intelligence plan by:
identifying, utilizing a large language model, relevant files to execute the software task;
identifying, utilizing the large language model, key findings to execute the software task; and
identifying, utilizing the large language model, implementation questions to execute the software task.

12. The system of claim 9, wherein the one or more processors are configured to cause the system to:
determine a multi-factor authentication as the autonomous software agent performs the one or more web-based tasks as part of executing the software task; and
receive, from the computing device controlled by the user, a multi-factor authentication input.

13. The system of claim 12, wherein the one or more processors are configured to cause the system to:
receive, via the graphical user interface, a selection of a browser control release option element; and
resume an execution of the software task in response to the selection of the browser control release option element.

14. The system of claim 9, wherein the one or more processors are configured to cause the system to:
provide, for display in the interactive browser, a user interface of an application running on the independent virtual machine computing environment; and
provide, for display in an interactive integrated development environment interface of the graphical user interface, an integrated development environment option element to usurp control of an integrated development environment from the autonomous software agent in the independent virtual machine computing environment.

15. The system of claim 14, wherein the one or more processors are configured to cause the system to:
in response to a selection of the integrated development environment option element, cede control of the integrated development environment on the independent virtual machine computing environment to a computing device controlled by a user;
receive, from the computing device controlled by the user, one or more modifications to stylistic user interface computer code written in the integrated development environment;
receive a selection from the computing device controlled by the user to switch to the interactive browser; and
provide, for display in the interactive browser, the user interface of the application, wherein the user interface is displayed according to the one or more modifications to the stylistic user interface computer code.

16. A non-transitory computer-readable medium storing executable instructions which, when executed by at least one processing device, cause the at least one processing device to perform operations comprising:
receiving, via a graphical user interface, a prompt to execute a software task by utilizing an autonomous software agent in an independent virtual machine computing environment;
providing, for display in the graphical user interface, a shell of the independent virtual machine computing environment; and
providing, for display in the shell, one or more commands automatically entered by the autonomous software agent as part of executing the software task.

17. The non-transitory computer-readable medium of claim 16, wherein providing the one or more commands automatically entered further comprises:
providing, for display in the shell, in-progress terminal commands from the autonomous software agent executing the software task; and
providing, for display in the shell, one or more outputs corresponding to the one or more commands automatically entered by the autonomous software agent.

18. The non-transitory computer-readable medium of claim 16, wherein providing the one or more commands automatically entered further comprises:
providing, for display in the shell, an option to copy a command entered by the autonomous software agent; and
providing, for display in the shell, an option to copy an output corresponding to the command entered by the autonomous software agent.

19. The non-transitory computer-readable medium of claim 16, further comprising:
providing, via the graphical user interface, a progress interface to follow a progress of the autonomous software agent executing the software task,
wherein the progress interface depicts shell commands, code edits, and browser activity.

20. The non-transitory computer-readable medium of claim 19, further comprising:
providing, via the progress interface, a plurality of steps within a development session from the autonomous software agent executing the software task;
receiving, via the progress interface, a selection of a step of the plurality of steps; and
providing, via the progress interface, an expanded view of the step that depicts details of the step that was executed or is being executed by the autonomous software agent.
